(19) United States
(12) Patent Application Publication
(10) Pub. No.: US 2015/0002515 A1
(43) Pub. Date: Jan. 1, 2015

(54) METHOD FOR DISPLAYING MULTI-GRADATION CHARACTERS, DEVICE FOR DISPLAYING MULTI-GRADATION CHARACTERS, TELEVISION RECEIVER PROVIDED WITH DEVICE FOR DISPLAYING MULTI-GRADATION CHARACTERS, MOBILE EQUIPMENT PROVIDED WITH DEVICE FOR DISPLAYING MULTI-GRADATION CHARACTERS, AND RECORDING MEDIUM

(71) Applicant: Sharp Kabushiki Kaisha, Osaka-shi, Osaka (JP)

(72) Inventors: Eriko Iguchi, Osaka-shi (JP); Hiroo Tadaki, Osaka-shi (JP)

(21) Appl. No.: 14/372,811

(22) PCT Filed: Sep. 28, 2012
(86) PCT No.: PCT/JP2012/075202

§ 371 Date: Jul. 17, 2014

(30) Foreign Application Priority Data
Jan. 18, 2012 (JP) 2012-008478

(51) Int. Cl. G06T 5/00; G06T 11/60

(52) U.S. Cl. CPC G06T 5/008; G06T 11/60; G06T 2210/36; G06T 2207/20012
USPC 345/469.1

(57) ABSTRACT

The present invention includes: a step (S5) of measuring a gradation difference between (i) each gradation of character font parts of multi-gradation characters and (ii) a gradation of a corresponding intermediate part between the multi-gradation characters; and a step (S6 through 9) of preparing corrected multi-gradation characters by correcting, in accordance with the gradation difference obtained in the step (S5), a gradation of each of the multi-gradation characters.

### TECHNICAL FIELD

The present invention relates to a method of displaying characters, a display device for displaying characters, a program for displaying characters, and the like, each of which is most suitably employed in a case where display devices of various information devices, typified by a television receiver, display characters as an OSD (On Screen Display). More specifically, the present invention relates to a method of displaying multi-gradation characters, a display device for displaying multi-gradation characters, a program for displaying multi-gradation characters, and a television receiver including the display device, each of which is most suitably employed in a case where characters to be displayed as an OSD is to be displayed as multi-gradation characters by adding a gradation of 1 or more to each contour of character fonts of the characters.

### BACKGROUND ART

Currently, television receivers and the like have a function of displaying characters as an OSD (On Screen Display). Such a function is used to display various pieces of character information. Although, in general, languages which the television receivers use are different depending on countries where the television receivers are used the television receivers have common configurations regarding the other hardware. That is, the television receivers are manufactured as television receivers having worldwide specification which television receivers have identical hardware configurations.

The television receivers having worldwide specification embed therein a large number of characters (character fonts) corresponding to a large number of languages so as to display OSDs in different languages. This allows a user and the like to select words (characters) in a target language.

In a case where the television receivers having worldwide specification switch languages and then display an OSD, the number of characters etc. of the translation sometimes greatly varies depending on the languages.

FIG. 12 illustrates such a case. It is assumed that, while characters “Hello” in English illustrated in (a) of FIG. 12 are being displayed in a display area 521, which is a predetermined space in a display screen 520, the language of the characters is switched to German so that the characters are displayed in German.

In a case where the word “Hello” is translated to German “Guten Morgen” and then displayed in the predetermined display area 521, the number of the characters of the word greatly changes from 5 in English to 12 in German (including a space). This sometimes results in that the characters are beyond a character box of the predetermined display area 521. (b) of FIG. 12 illustrates a case where the characters are beyond the character box of the predetermined display area 521.

Meanwhile, on a screen on which an OSD is displayed, it is sometimes required to display the translation inside the predetermined display area 521 due to a requirement for a screen design. In such a case, it is necessary to adjust, for example, inter-character spaces so that the character string to be displayed is displayed inside the predetermined display area 521. (c) of FIG. 12 illustrates a state where the inter-character spaces are adjusted so that the character string “Guten Morgen” is fitted in the predetermined display area 521.

Furthermore, in a case where alphanumeric characters are loaded at regular intervals with identical font sizes, an inter-character space between some of, especially, the alphanumeric characters becomes sometimes too large. This causes the entire character string to be unbalanced and accordingly causes a feeling of strangeness about display of the character string. This is particular to a case where a text including both Japanese and the alphanumeric characters is displayed.

Cited Document 1 discloses such a technique that, in a case where a character display control device having a bitmap memory system displays various characters, the character display control device evenly displays the various characters by properly setting an inter-character space.

FIG. 13 is a block diagram illustrating a configuration of the character display control device disclosed in Patent Literature 1 which device properly sets an inter-character space. In FIG. 13, in a case where character codes are supplied from a CPU 501 to a character code determining circuit 506, the character code determining circuit 506 determines the character codes and then determines whether or not an inter-character space between characters of the character codes should be adjusted. A character width determining circuit 508 generates, in accordance with a result of the determination carried out by the character code determining circuit 506, character width information on a character pattern of one of the characters which one is accessed by a character pattern memory 503. A calculation circuit 510 properly adjusts, in accordance with the character width information, the inter-character space, in a lateral direction, of the character pattern of the one of the characters.

Specifically, in a case where an alphabet “I” is displayed on a display screen of a display device, the number of dots in a lateral direction of a font of the alphabet “I” is three dots. Since the number is much lower than the number of dots of an entire character pattern of the alphabet “I” (for example, eight dots), the alphabet “I” may be illegible because an inter-character space is too large when the alphabet “I” is displayed as a character string. According to the technique disclosed in Patent Literature 1, it is possible to adjust the inter-character space to a proper space with respect to such a character.

Recently, in a case where a character is displayed as an OSD, high-quality character is sometimes used, the high-quality character being a character in multi-gradation, that is, a character in which a gradation of 1 or more, which are different in brightness (or luminance), is added to a contour of a character font (hereinafter, merely referred to as “a gradation of 1 or more”) so that an end or a curved part of the character is smoothed.

FIG. 14 illustrates an example of a character in multi-gradation in which two gradations (gradation 1 and gradation 2) are added to a contour of a character font. Note that an upper half part of FIG. 14 illustrates an example of a character “e” in multi-gradation (hereinafter, a character in multi-gradation will be also referred to as a “multi-gradation character”) in which two gradations (gradation 1 and gradation 2) are added to a contour of a character font, whereas a lower half part of FIG. 14 illustrates, with a simple graph, (i) gradation (hereinafter, also referred to as a “level of brightness (luminance)” in the specification) of a part 530 of the character font (hereinafter, also merely referred to as a “character font 530”) of the multi-gradation character “e”, (ii) a gradation of a part 531 to which the gradation 1 is added (hereinafter, merely referred to as a “gradation 1 part 531”) (iii) a gradation of a part 532 to which the gradation 2 is added (hereinafter, merely referred to as a “gradation 2 part 532”); and (iv) a gradation of a background 533.

As is clear from the upper half part of FIG. 14, the multi-gradation character “e” is displayed, in which the gradation 1 part 531 and the gradation 2 part 532 are added to a periphery (contour) of the character font 530, which is an original character font of a character “e”. The lower half part of FIG. 14 illustrates, with the simple graph, the gradation (level of brightness (luminance)) of each of the character font 530, the gradation 1 part 531, the gradation 2 part 532, and the background 533.

As is clear from the graph showing the gradations (levels of brightness), the gradation 1 part 531 and the gradation 2 part 532 are provided whose levels of brightness (luminance) substantially evenly divide a difference between the level of brightness (luminance) of the character font 530 and the level of brightness (luminance) of the background 533 (see the example illustrated in FIG. 14). According to FIG. 14, a width of a line making up the character font 531 (a width of a line of the character) is illustrated so as not to differ so much from those of the gradation 1 part 532 and the gradation 2 part 533. However, the widths of the gradation 1 part 531 and the gradation 2 part 532, each of which is added to the contour of the character font, can be each narrower relative to the width of the line of the character font 531. Note that the graph illustrated in the lower half part of FIG. 14 shows the levels of brightness (luminance) measured along a line segment A-A′ illustrated in the upper half part of FIG. 14.

### CITATION LIST

Patent Literature 1
Japanese Patent Application Publication, Tokukaihei, No. 5-241557 A (Publication Date: Sep. 21, 1993)

### SUMMARY OF INVENTION

### Technical Problem

Even in a case where a television receiver having worldwide specification, which is capable of displaying an OSD in multiple languages, switches languages, it is necessary to, for example, (1) display a text while reducing an inter-character space, (2) display the text with a small character size, and/or (3) display the text while scrolling it when the text is selected, in order to display in an identical box the text having an identical context in consideration of a design of a display screen.

In a case where a length (the number of characters) of the text whose language has been switched to another does not differ so much from an original length, it is possible to fit the text in a predetermined display area by use of any of the above techniques. However, visibility of the text displayed by use of any of the techniques may become worse. In a case of scroll display, it is possible to display the text even in a case where the text whose language has been switched to another is long. However, time is required for the entire text to be recognized. Moreover, since the entire text is scrolled, the visibility of the text still becomes worse.

Displaying the text while reducing or narrowing the inter-character space causes the text to least deteriorate in visibility, in a case where the number of the characters has not been so increased. However, in a case where (i) the text is displayed with the use of high-quality multi-gradation characters described with reference to FIG. 14 and (ii) the text is displayed while the inter-character space is being narrowed, this may cause the text to deteriorate in visibility.

FIG. 15 is a view illustrating, in a case where multi-gradation characters are used, how visibility changes when inter-character spaces are narrowed. FIG. 15 includes (a) through (e) of FIG. 15. Each of (a) through (e) of FIG. 15 has an upper part, a middle part, and a lower part. The upper part of each of (a) through (e) of FIG. 15 illustrates a state where a character string “ABCD” is displayed while being fitted in a space having a different width (indicated by pixels). The middle part of each of (a) through (e) of FIG. 15 illustrates, in more detail, the state with focus on contours of respective adjacent characters of the character string “ABCD”. The lower part of each of (a) through (e) of FIG. 15 illustrates the adjacent characters, illustrated in a corresponding middle part, with the use of levels of brightness (luminance).

For convenience, FIG. 15 illustrates, as an example, characters in each of which a “gradation 1” is added to a contour of a character font. That is, FIG. 15 illustrates character fonts 540, gradation 1 parts 541 which are added to respective contours of the character fonts 540, and a background 542. In FIG. 15, a level 543 indicates levels of brightness of the character fonts 540, a level 544 indicates levels of brightness of the gradation 1 parts 541, and a level 545 indicates a level of brightness of the background 542.

In a case where the character string “ABCD” is displayed while being fitted in a sufficiently-large space (width) (see (a) of FIG. 15), an inter-character space between the adjacent characters of the character string “ABCD” is sufficiently large (see a space 546). In a case where the character string “ABCD” is fitted in a space having a width of 90 pixels or so (see (b) of FIG. 15), the inter-character space between the adjacent characters is narrower (see a space 547) than the space 546. However, in either case, the background 542 exists, in great width, between the adjacent characters. Therefore, the character string “ABCD” does not deteriorate in visibility.

In a case where the character string “ABCD” is fitted in a further narrower space, for example, a space having a width of 80 pixels or so (see (c) of FIG. 15), the inter-character space between the adjacent characters is further narrower (see a space 547′). Although the background 542 remains between the adjacent characters, the character string “ABCD” deteriorates in visibility, for example, in a case where the character string “ABCD” is looked at from a distant place. In a case where the character string “ABCD” is fitted in a still narrower space, for example, a space having a width of 70 pixels or so (see (d) of FIG. 15), the gradation 1 parts 541 of the respective adjacent characters are in direct contact with each other, so that no background 542 remains between the adjacent characters. As a result, the character string “ABCD” is not sufficiently contrasted. This causes the character string “ABCD” to deteriorate in visibility.

In a case where the character string “ABCD” is fitted in a much narrower space (see (e) of FIG. 15), the character fonts 540 of the respective adjacent characters are extremely close to each other (see a space 548). This results in that only the gradation 1 parts 541, which have brightness rather close to those of the character fonts 540, are sandwiched between the character fonts 540. It follows that contrast between the adjacent characters is lower and, accordingly, the character string “ABCD” extremely deteriorates in visibility.

As has been described, there is a problem that, in a case where it is intended that a character string, displayed as multi-gradation characters by adding a gradation of 1 or more to each contour of character fonts of inputted character data, is displayed while being fitted in a narrower space, the character string deteriorates in visibility.

According to the technique disclosed in Cited Document 1, even in a case where a character string includes a character whose size in a width direction is small, it is possible to display the character string with some degree of visibility and possible to reduce, depending on a circumstance, a width of the entire character string to some extent. This is because it is possible to adjust an inter-character space to a proper space with respect to such a character. However, no consideration is given to a character displayed as a multi-gradation character by adding a gradation of 1 or more to a contour of character font of inputted character data. Therefore, it is not possible to solve the problem with the use of the technique disclosed in Cited Document 1.

The present invention has been made in view of the above problem, and an object of the present invention is to provide a method of displaying multi-gradation characters, a display device for displaying multi-gradation characters, and the like, each of which is capable of, even in a case where a character string contains multi-gradation characters, in each of which a gradation of 1 or more is added to a contour of a character font, is fitted in a narrower space, displaying the inputted character data as a multi-gradation character to a maximum extent while minimizing a deterioration in visibility.

### Solution to Problem

In order to attain the above object, a method of displaying multi-gradation characters in accordance with the present invention is a method of displaying multi-gradation characters, which method allows inputted character data to be displayed as multi-gradation characters by adding a gradation of 1 or more to each contour of character fonts of the inputted character data, the method including the steps of: (a) generating the multi-gradation characters by adding the gradation of 1 or more to the each contour of the character fonts of the inputted character data; (b) measuring a gradation difference between (i) each gradation of character font parts of the multi-gradation characters and (ii) a gradation of a corresponding intermediate part between adjacent ones of the multi-gradation characters; and (c) generating corrected multi-gradation characters by correcting the gradation of 1 or more of each of the multi-gradation characters in accordance with the gradation difference measured in the step (h), in accordance with the gradation difference measured in the step (b), the corrected multi-gradation characters being outputted instead of characters to each of which no gradation is added.

Further, in order to attain the above object, a display device for displaying multi-gradation characters in accordance with the present invention is a display device, including a character gradation generating section which generates multi-gradation characters by adding a gradation of 1 or more to each contour of character fonts, said display device allowing inputted character data to be displayed as the multi-gradation characters, in each of which the gradation of 1 or more is added to the each contour of the character fonts, the display device including: a gradation difference measuring section for measuring a gradation difference between (i) each gradation of character font parts of the multi-gradation characters and (ii) a gradation of a corresponding intermediate part between adjacent ones of the multi-gradation characters; and a switching section for switching, in accordance with the gradation difference measured by the gradation difference measuring section, between (i) outputting of characters to each of which no gradation is added and (ii) outputting of the multi-gradation characters which are generated by the character gradation generating section and in each of which the gradation of 1 or more is added to the each contour of the character fonts.

In order to attain the above object, a display device for displaying multi-gradation characters in accordance with the present invention is a display device, including a character gradation generating section which adds a gradation of 1 or more to each contour of character fonts, said display device allowing inputted character data to be displayed as multi-gradation characters in each of which the gradation of 1 or more is added to each contour of character fonts, the display device including: a gradation difference measuring section for measuring a gradation difference between (i) each gradation of character font parts of the multi-gradation characters and (ii) a gradation of a corresponding intermediate part between adjacent ones of the multi-gradation characters; and a corrected multi-gradation character generating section for generating corrected multi-gradation characters by correcting the gradation of 1 or more of each of the multi-gradation characters generated by the character gradation generating section, said display device being capable of switching, in accordance with the gradation difference measured by the gradation difference measuring section, between (i) characters to each of which no gradation is added and (ii) the corrected multi-gradation characters.

### Advantageous Effects of Invention

According to the present invention, it is possible to display high-quality characters, that is, multi-gradation characters while securing (i) a some degree of display quality and (ii) necessary visibility, even in a case where an inter-character space between the multi-gradation characters is narrowed, for such a reason that a predetermined display space has been narrowed, while the multi-gradation characters are being displayed in the predetermined display space.

### BRIEF DESCRIPTION OF DRAWINGS

FIG. 1 is a flow diagram illustrating a method of displaying multi-gradation characters in accordance with Embodiment 1 of the present invention.

FIG. 2 is a view for explaining (i) a state where multi-gradation characters, in each of which a gradation of 1 or more is added to a contour of a character font, are displayed while being fitted in a narrower space and (ii) a state where the multi-gradation characters to which the present invention has been applied are displayed.

FIG. 3 is a view illustrating an example of a display device to which the method of displaying multi-gradation characters in accordance with Embodiment 1 of the present invention can be applied.

FIG. 4 is a view illustrating examples of multi-gradation characters.

FIG. 5 is a view for explaining an example state where the multi-gradation characters are displayed to which Embodiment 1 of the present invention is applied.

FIG. 6 is a view for explaining another example state where the multi-gradation characters are displayed to which Embodiment 1 of the present invention is applied.

FIG. 7 is a view illustrating an example of multi-gradation characters to which the present invention can be applied and in which differences in gradation vary depending on gradations.

FIG. 8 is a view illustrating a method of displaying multi-gradation characters in accordance with Embodiment 2 of the present invention.

FIG. 9 is a view illustrating a state where multi-gradation characters are displayed to which Embodiment 2 of the present invention is applied.

FIG. 10 is a view illustrating an example of a display device to which the method of displaying multi-gradation characters in accordance with Embodiment 2 of the present invention can be applied.

FIG. 11 is a view illustrating an example of a circuit configuration of a television receiver which includes an OSD processing section and to which the present invention can be applied.

FIG. 12 is a view for explaining a case where texts which are different in number of characters are displayed in a predetermined area.

FIG. 13 is a view illustrating a conventional method of controlling characters in which method an inter-character space between fonts is adjusted for each font.

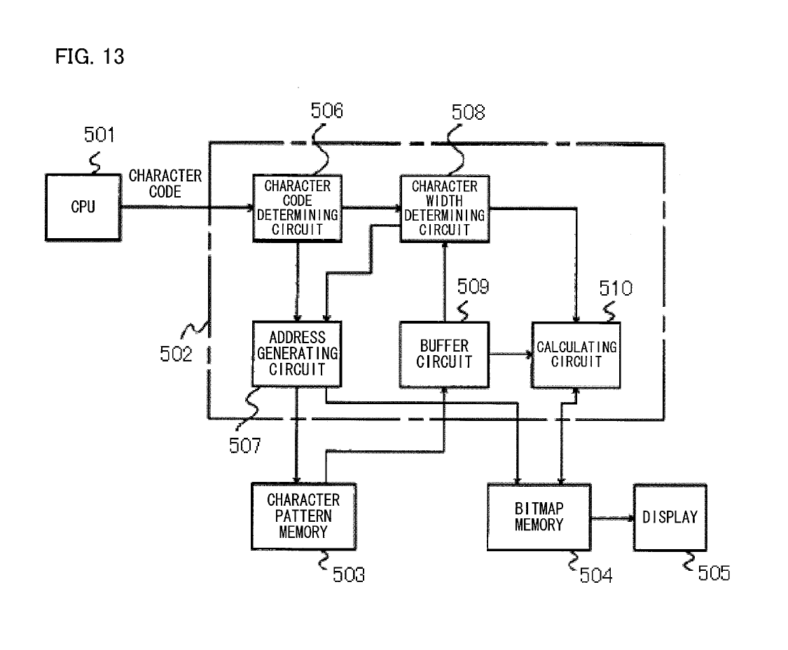

FIG. 14 is a view illustrating an example configuration of a multi-gradation character.

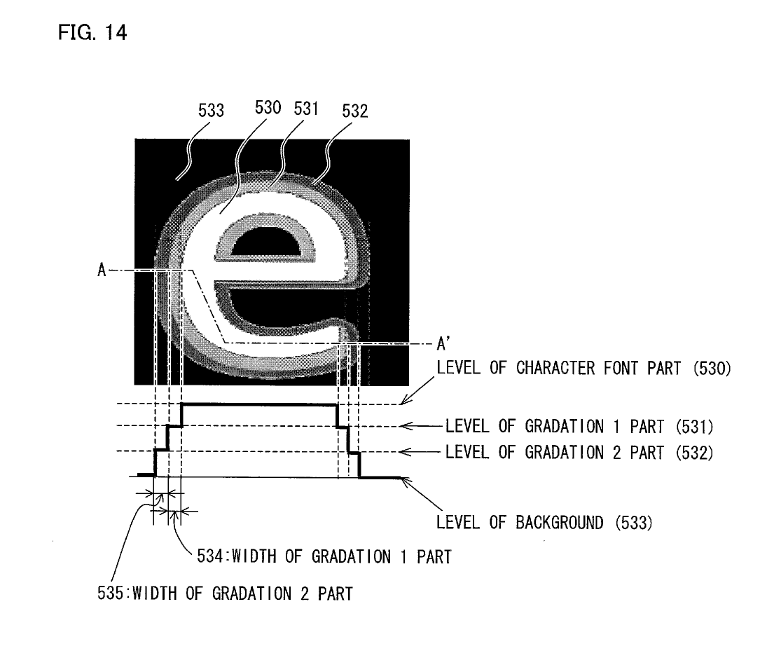

FIG. 15 is a view illustrating a state where multi-gradation characters are displayed while inter-character spaces between the multi-gradation characters are being narrowed.

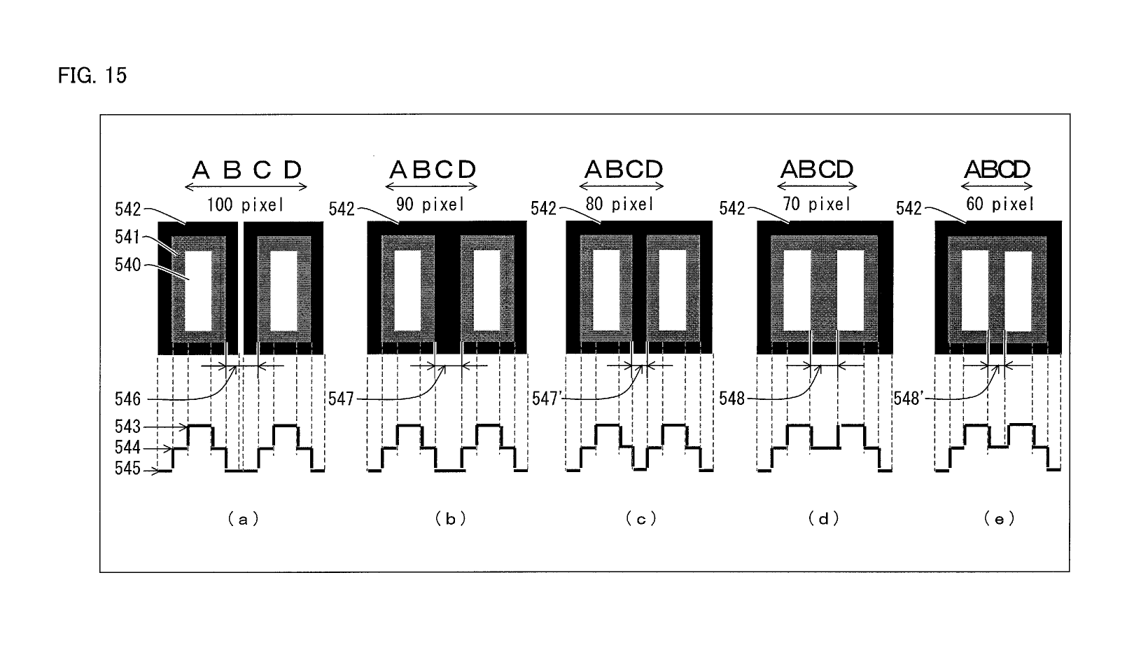

### DESCRIPTION OF EMBODIMENTS

The following description will discuss, in detail, Embodiments of the present invention with reference to drawings. Note that, in the following description, various limitations are given which are preferable in order that the present invention is worked out, but a technical scope of the present invention is not limited to the descriptions of the following Examples and drawings.

### EMBODIMENTS

Embodiments of the present invention will be described with reference to the drawings. In the following description, identical reference numbers are given to identical members and the like, and detailed descriptions of the members and the like will not be repeated.

### Embodiment 1

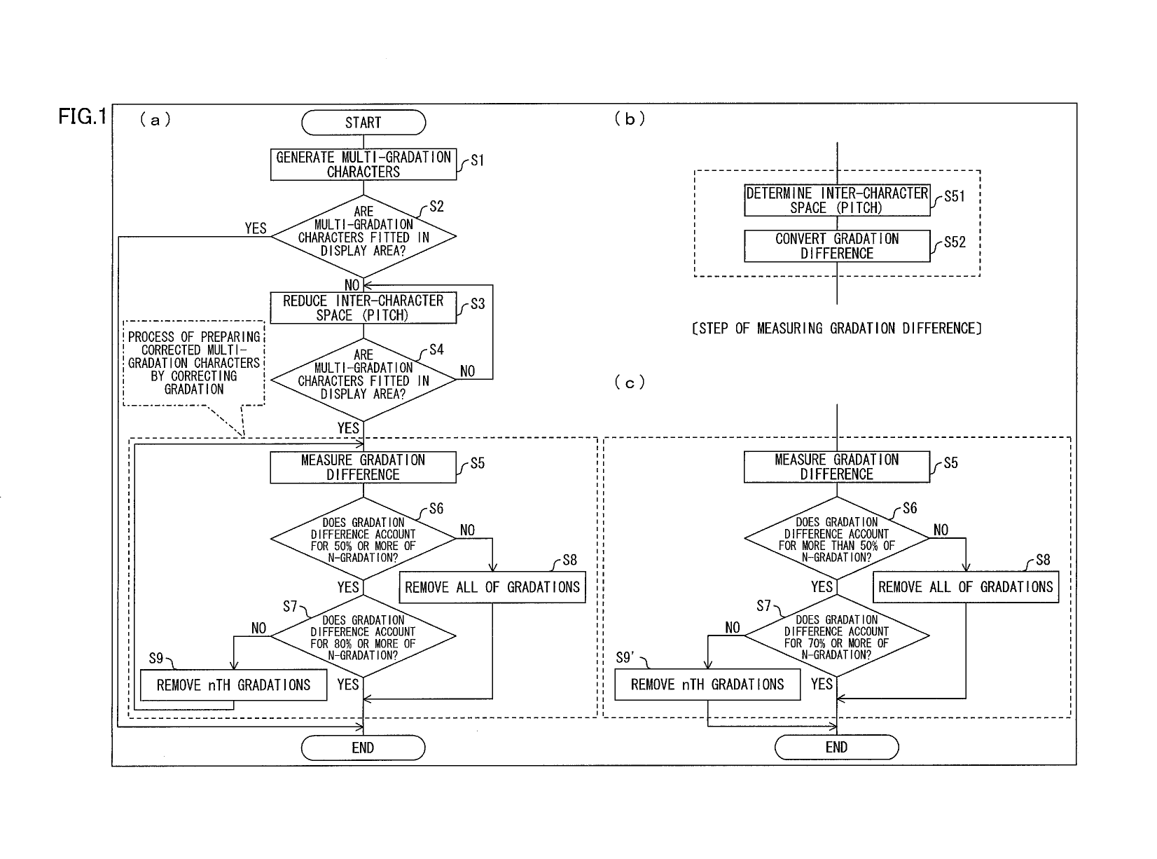

The following description will discuss Embodiment 1 of the present invention with reference to FIGS. 1 through 7.

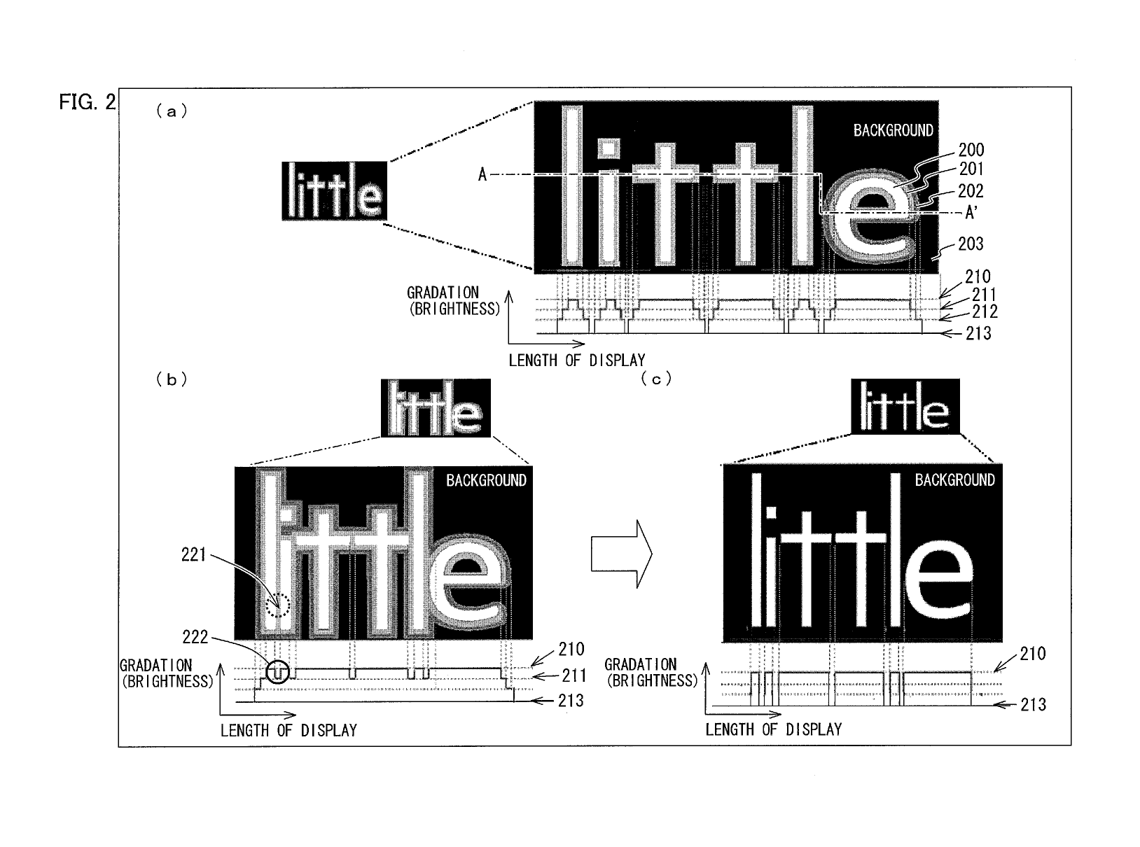

FIG. 1 is a flowchart illustrating a method of displaying multi-gradation characters in accordance with Embodiment 1 of the present invention. FIG. 2 is a view for schematically illustrating how multi-gradation characters are displayed in a case where the method of displaying multi-gradation characters in accordance with the present invention is applied to the multi-gradation characters while the multi-gradation characters are being displayed.

First, a general outline of the method of displaying multi-gradation characters in accordance with the present invention will be described with reference to FIG. 2. An upper part of each of (a), (b) and (c) of FIG. 2 illustrates a state where a character string “little,” which contains multi-gradation characters, is displayed. A lower part of each of (a), (b) and (c) of FIG. 2 illustrates a graph of how such multi-gradation characters are displayed with gradations (levels of brightness).

Furthermore, FIG. 2 illustrates an example of a character string in which two gradations are added to a contour of each character font of the multi-gradation characters of the character string “little.” (a) of FIG. 2 illustrates an example case where the character string “little” is displayed while inter-character spaces are not being reduced. (b) of FIG. 2 illustrates an example case where the character string “little” is displayed while the inter-character spaces are being reduced. (c) of FIG. 2 illustrates an example case where visibility of displayed multi-gradation characters is improved, by changing a method of displaying multi-gradation characters into the method in accordance with the present invention in a case where the displayed multi-gradation characters have been deteriorated in visibility as a result of a reduction in inter-character spaces.

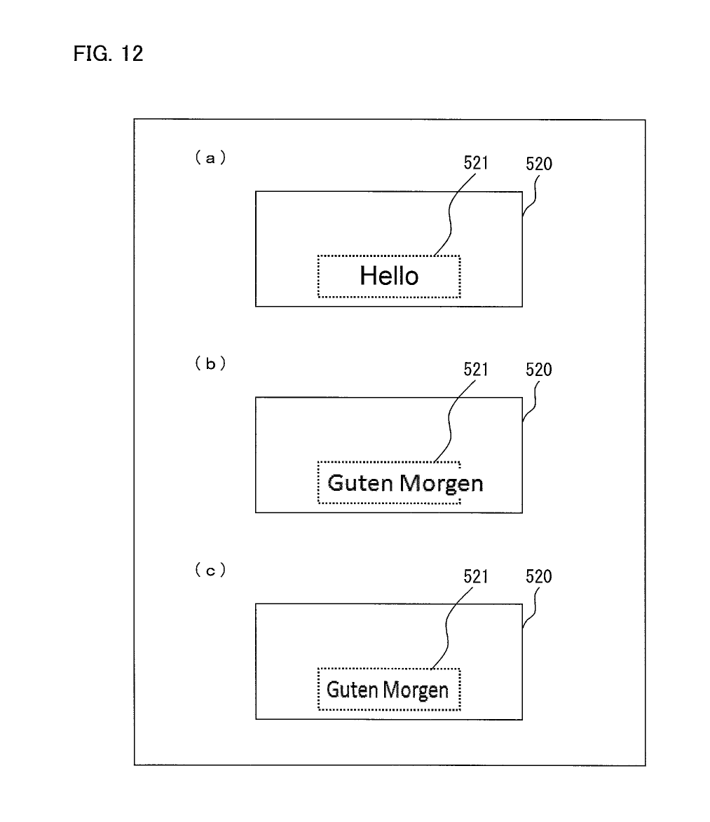

Note that the case as described with reference to, for example, FIG. 12 is a typical example of a case where inter-character spaces of a displayed character string become narrower. Therefore, it is understood that, in a case of switching, to multilingual display, a television receiver or the like having worldwide specification, it is extremely effective to employ the method of displaying multi-gradation characters (described below) of the present invention.

Note, however, that a case to which the present invention can be applied is not limited to such a case. For example, the present invention can be employed, for example, in a case where the television receiver (i) performs PIP (Picture In Picture) display, in which another channel is displayed on a sub screen on a screen, and (ii) displays a given character string on a small screen on the sub screen without changing a design of the sub screen.

In the graph illustrated in the lower part of each of (a), (b), and (c) of FIG. 2, a level 210 indicates gradations (levels of brightness) of parts 200 of the character fonts (hereinafter, merely referred to as “character fonts”), a level 211 indicates gradations (levels of brightness) of parts 201 to each of which a gradation 1 is added (hereinafter, merely referred to as “gradation 1 parts”), a level 212 indicates gradations (levels of brightness) of parts 202 to each of which a gradation 2 is added (hereinafter, merely referred to as “a gradation 2 part(s)”), and a level 213 indicates a gradation (level of brightness (or luminance)) of a background 203. Note that, as has been described, the phrase “gradation of the character font 200” and the like will be also referred to as “level of brightness (or luminance) of the character font 200” or merely “level of brightness of the character font 200,” instead.

As is clear from (a) of FIG. 2, in a case where the character string “little” is displayed in a normal state, that is, the character string “little” is displayed with sufficient spaces (specifically, in a case where the background 203 exists, in a sufficient width, between the multi-gradation characters), there is no problem with the visibility of the character string. This is because, even in a case where, for example, two gradations ((i) the gradation 1 parts 201, which are slightly darker than the character font parts 200, and (ii) the gradation 2 parts 202, which are darker than the gradation 1 parts 201 but brighter than the background 203) are added to each of contours of the character fonts, such multi-gradation parts added to the contours are apart from each other and, furthermore, the background 203 exists between the multi-gradation characters. On the contrary, since a gradation is added to each contour of the character fonts, characters are each displayed with high quality without feeling no jag that will easily occur in, for example, a curved part of a character.

(b) of FIG. 2 illustrates a state where a character string should be displayed while a length of the character string is being reduced for some reason, for example, for such a reason that has been described with reference to FIG. 12. In a case where characters of the character string are multi-gradation characters (see (b) of FIG. 2), an inter-character space between respective adjacent ones of the multi-gradation characters is extremely narrowed, depending on a degree of the reduction in length of the character string. This may cause gradation 2 parts 202, each of which is added to the contour of a corresponding one of the character fonts, not to be displayed. In this case, a gradation 1 part 201 narrowly remains between the respective adjacent ones of the multi-gradation characters.

In this case, as is clear from the graph illustrated in the lower part of (b) of FIG. 2, such a gradation 1 part 201 (part whose brightness is at the level 211) merely exists between the respective adjacent ones of the multi-gradation characters. It follows that the entire character string is low in contrast with bad visibility.

In view of the circumstances, in a case where the character string has such a gradation difference that causes a deterioration in visibility, the gradations of the gradation 1 parts 201, which are added to the respective character fonts 200, and/or the gradations of the gradation 2 parts 202, which are added to the respective character fonts 200, are corrected. (c) of FIG. 2 illustrates, as an example of correcting the gradations, the character fonts 200 from which the gradation 1 parts 201 and the gradation 2 parts 201 are deleted. In this case, all of such gradation parts are consequently deleted. This causes some reduction in quality of display of the characters, but gives rise to display excellent in visibility. Note that, in the present invention, the “gradation difference” is used as a synonym of a difference in brightness between two gradations, for example, a difference in brightness (or luminance) between the “gradation 1 parts 201” and the “gradation 2 parts 202.”

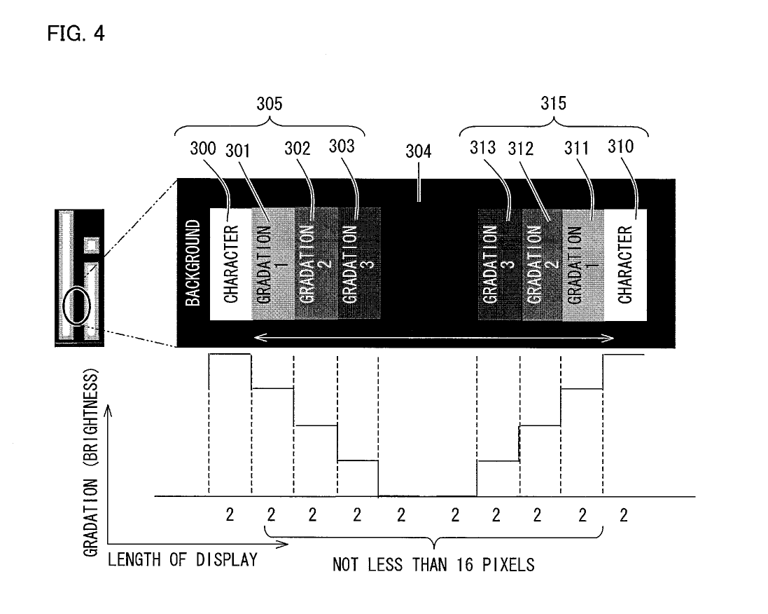

According to the example illustrated in FIG. 2, a gradation difference is measured between (i) each gradation (brightness) of the character fonts 200 and (ii) a gradation (brightness) of a corresponding intermediate part between adjacent ones of the multi-gradation characters. In a case where a measured gradation difference is such a difference that causes a deterioration in visibility, the gradations of the gradation 1 parts 201 of the respective multi-gradation characters and/or the gradations of the gradation 2 parts 202 of the respective multi-gradation characters are corrected, and the multi-gradation characters whose respective gradations thus corrected (corrected multi-gradation characters) are displayed. In this case, by appropriately selecting a degree of the correction, for example, by removing all added gradations as illustrated in (c) of FIG. 2, it is possible to sandwich, between the respective characters displayed, a part which is as bright as the background. This makes it possible to display the characters with good visibility. Note that other aspects of correcting a gradation of a multi-gradation character will be described in more detail with reference to FIGS. 4 through 6 etc.

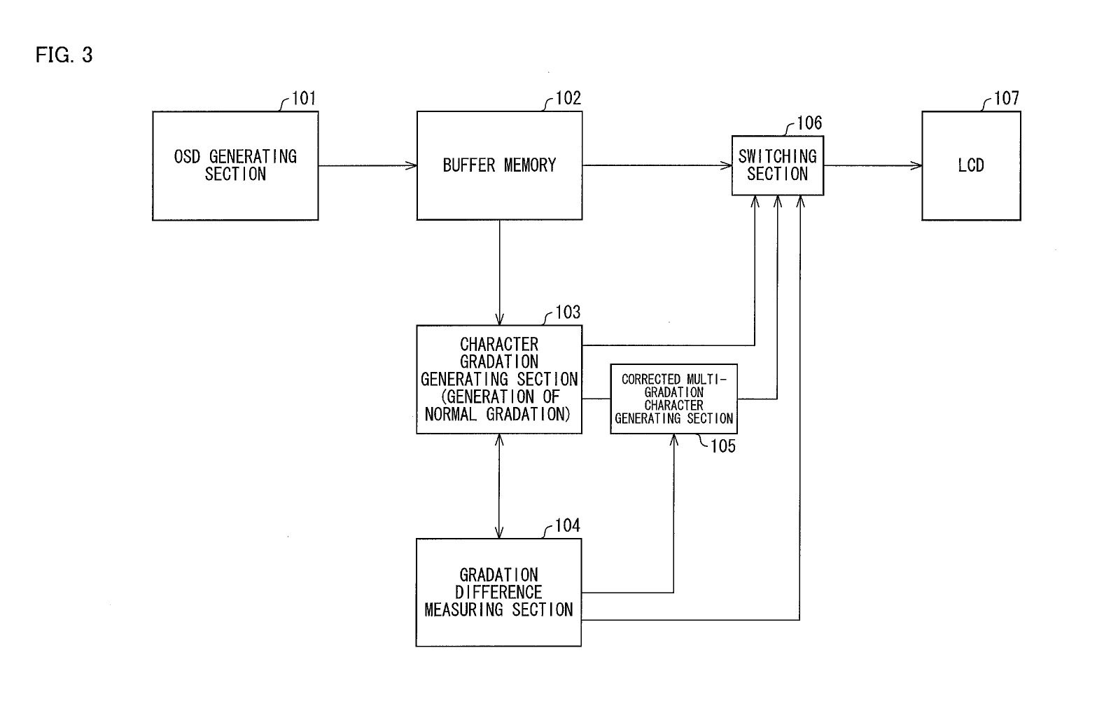

The following description will discuss, with reference to FIGS. 1 and 3, (i) flows for achieving the display illustrated in FIG. 2 and (ii) an example of a display device for displaying multi-gradation characters which device is capable of carrying out the flows. FIG. 1 is a flow chart illustrating the method of displaying multi-gradation characters in accordance with Embodiment 1 of the present invention. FIG. 3 is a view illustrating an example of the display device for displaying multi-gradation characters which device is capable of carrying out such flows.

In FIG. 3, the display device is illustrated as a display device which can employ the method of displaying multi-gradation characters of the present invention by being connected to a device of, for example, a television receiver which device displays an OSD. In FIG. 3, an OSD generating section 101 is a section of a television receiver which section displays an OSD, as described above. The OSD generating section 101 displays, on a screen, program information, information regarding operation of the television receiver, or the like.

Note that the OSD generating section 101, a character gradation generating section 103 (later described), a gradation difference measuring section 104 (later described), a corrected multi-gradation character generating section 105 (later described), and a switching section 106, each of which is illustrated in FIG. 3, are controlled by a CPU (not illustrated in FIG. 3) provided in a main body of the television receiver or the like.

In FIG. 3, character string data, which is outputted from the OSD generating section 101 and whose character string is to be displayed as an OSD, is first stored in a buffer memory 102. The flow chart of FIG. 1 illustrates a display method in which (i) the character string data is read out from the buffer memory 102 illustrated in FIG. 3, (ii) the character string data is converted into multi-gradation characters, and (iii) the multi-gradation characters thus converted are displayed in a predetermined display area.

In FIG. 1, in a case where the character gradation generating section 103 receives, from the buffer memory 101, the character string data whose character string is to be displayed, the character gradation generating section 103 generates multi-gradation characters by adding a gradation of 1 or more to a contour of each of character fonts (step S1). Because the character string in accordance with the character string data supplied from the OSD generating section 101 is usually displayed in the predetermined display area, the character gradation generating section 103 determines whether or not a character string containing the multi-gradation characters, to each of which the gradation of 1 or more is added, is to be fitted in the predetermined display area (step S2). This determination can be made with the use of a CPU (not illustrated) for controlling the display device or can be alternatively made with the use of, for example, the CPU of the television receiver as has been described.

In a case where it is determined that the character string containing the multi-gradation characters is not fitted in the predetermined display area, the character gradation generating section 103 reduces an inter-character space (pitch) between the respective multi-gradation characters (step S3), and then determines again whether or not the character string whose inter-character space is thus reduced is fitted in the predetermined display area (step S4). The character gradation generating section 103 repeats the steps S3 and S4 until the character string containing the multi-gradation characters is fitted in the predetermined display area.

After the character gradation generating section 103 determines that the character string containing the multi-gradation characters is fitted in the predetermined display area, the gradation difference measuring section 104 measures a gradation difference between (i) each gradation of the character fonts 200 and (ii) a gradation of a corresponding intermediate part between adjacent ones of the multi-gradation characters (step S5). For example, according to (b) of FIG. 2, the gradation of the intermediate part between the adjacent ones of the multi-gradation characters is indicated by a gradation of a part 221, that is, indicated by the “gradations 1” in the respective multi-gradation characters. The gradation difference becomes a difference between the level 210 of brightness (or luminance) of the character fonts 200 and the level 211 of brightness (or luminance) of the added gradation 1 parts 201 (see a circle 222 illustrated in (h) of FIG. 2).

The measurement of the gradation difference can be made, for example, by (i) storing in advance brightness of the character font parts 200, the gradation 1 parts 201, the gradation 2 parts 202, and the background and (ii) calculating the gradation difference based on the multi-gradation characters which are loaded in a memory while an inter-character space is being reduced.

(b) of FIG. 1 illustrates another method of measuring the gradation difference. This measuring method is as follows. In general, in a case where a gradation is added to a contour of each of character fonts, a level of brightness and a width (pitch) of such a gradation are predetermined. Therefore, as illustrated in (b) of FIG. 1, by determining the inter-character space (pitch), it is possible to convert the gradation difference between (i) “each gradation of the character fonts 200” and (ii) the “gradation of a corresponding intermediate part between adjacent ones of the multi-gradation characters.”

The corrected multi-gradation character generating section 105 prepares corrected multi-gradation characters, by correcting, in accordance with the gradation difference thus obtained via the measurement, a gradation of each of the multi-gradation characters generated by the character gradation generating section 103.

FIG. 1 illustrates an example of how to correct the gradation of each of the multi-gradation characters. For example, it is assumed that there is N-gradation in total, from the brightness of the character font parts (referred to as gradation 0 (zero)) to the brightness of the background (referred to as gradation N). The corrected multi-gradation character generating section 105 determines whether or not the gradation difference measured in the step S5 accounts for 50% or more of the N-gradation (step S6). In a case where the gradation difference accounts for less than 50% of the N-gradation, the corrected multi-gradation character generating section 105 removes all of gradations (step S8). That is, a gradation difference corresponding to 50% of the N-gradation is set as a first gradation difference. In a case where the gradation difference is less than the first gradation difference, the corrected multi-gradation character generating section 105 removes all of the gradations.

In a case where the gradation difference accounts for 50% or more of the N-gradation, the corrected multi-gradation character generating section 105 determines whether or not the gradation difference accounts for 80% or more of the N-gradation (step S7). In a case where the gradation difference accounts for less than 80% of the N-gradation, the corrected multi-gradation character generating section 105 removes the nth gradation, which is a gradation farthest from a gradation of a character font part (step S9). The gradation difference measuring section 104 measures again a gradation difference (step S6), and the corrected multi-gradation character generating section 105 determines again whether or not the gradation difference accounts for 80% or more of the N-gradation (step S7). In a case where the corrected multi-gradation character generating section 105 determines that the gradation difference accounts for 80% or more of the N-gradation, the corrected multi gradation character generating section 105 completes gradation correction processing. That is, a gradation difference corresponding to 80% of the N gradations is set as a second gradation difference. In a case where the corrected multi-gradation character generating section 105 determines that the gradation difference is equal to or more than the second gradation difference, the corrected multi-gradation character generating section 105 completes the gradation correction processing.

Needless to say, in a case where it is determined, in the step S2, that the multi-gradation characters generated are fitted in the display area, the process is finished without gradation correction. Note that the gradation difference, based on which the corrected multi-gradation character generating section 105 determines whether to make a gradation correction, is not limited to 80% of the N-gradation, but can be alternatively, for example, 75% of the N-gradation. In a case where this percentage is lowered, an effect of improvement in visibility is somewhat reduced. In contrast, a ratio becomes higher at which the multi-gradation characters, which are high-quality characters, are displayed as they are.

Note that, in a case where the gradation difference is determined, in the step S7, to account for less than 80% of the N-gradation, the corrected multi-gradation character generating section 105 removes a gradation until the gradation difference accounts for 80% or more of the N-gradation. Note, however, that the corrected multi-gradation character generating section 105 is not limited to such. The corrected multi-gradation character generating section 105 can alternatively employ a simpler method.

(c) of FIG. 1 illustrates an example of such a simpler method. In this case, it is determined, in the step S7, whether or not the gradation difference accounts for 70% or more of the N-gradation. In a case where the gradation difference accounts for 70% or more of the N-gradation, the multi-gradation characters are displayed as they are. In a case where the gradation difference accounts for less than 70% of the N-gradation, the nth gradation is removed, that is, out of the gradations added to the contour of each of the character fonts, the gradation farthest from the gradation of the each of the character fonts is removed. Even by use of such a simple display method, the gradation difference of not less than 50% at the lowest is secured and, accordingly, the visibility of the multi-gradation characters is secured to some extent.

As has been described, the steps S5 through S9 or the steps S5 through S9′ constitute (a) a step of measuring a gradation difference between (i) each gradation of character font parts of multi-gradation characters and (ii) a gradation of a corresponding intermediate part between adjacent ones of the multi-gradation characters and (b) a step of preparing corrected multi-gradation characters by correcting, in accordance with the gradation difference obtained in the step (a), a gradation of each of the multi-gradation characters.

With reference to FIGS. 4, 5, and 6, the following description will discuss, in more detail, how to correct a gradation of each of multi-gradation characters so as to prepare corrected multi-gradation characters.

FIG. 4 illustrates a state where multi-gradation characters 305 and 315 are adjacently displayed while being spaced sufficient to avoid bad visibility. According to the multi-gradation character 305, three gradations, i.e., a gradation 1 part 301, a gradation 2 part 302, and a gradation 3 part 303 are added to a character font 300. According to the multi-gradation character 315, three gradations, i.e., a gradation 1 part 311, a gradation 2 part 312, and a gradation 3 part 313 are adjacent to each other and are added to a character font 310. Note that, for convenience, reference numerals, given to the respective three gradations which are added to the character font 300 of the multi-gradation character 305, are different from those given to the respective three gradations which are added to the character font 310 of the multi-gradation character 315 (see FIG. 4). Note, however, that the three gradations of the multi-gradation character 305 are identical, in brightness level, to the respective three gradations of the multi-gradation character 315 (see a graph illustrated in a lower part of FIG. 4).

The gradation 1 part 301, the gradation 2 part 302, and the gradation 3 part 303 of the multi-gradation character 305 each have a width of 2 pixels. Similarly, the gradation 1 part 311, the gradation 2 part 312, and the gradation 3 part 313 of the multi-gradation character 315 each have a width or 2 pixels. The multi-gradation characters 305 and 315 are displayed so that the gradation 3 part 303 of the multi-gradation character 305 is apart, by at least not less than 2 pixels, from the gradation 3 part 313 of the multi-gradation character 315. It follows that the character font 300 of the multi-gradation character 305 is apart, by not less than 16 pixels, from the character front 310 of the multi-gradation character 315. With such a configuration, the multi-gradation characters 305 and 315 are displayed with sufficient contrast. Therefore, no problem of visibility will occur while the multi-gradation characters 305 and 315 are being ordinarily displayed.

As has been described, the multi-gradation character 305 illustrated in FIG. 4 is arranged such that a gradation difference (difference in brightness) between the character font 300 and the gradation 1 part 301 is identical to those (i) between the gradation 1 part 301 and the gradation 2 part 302, (ii) between the gradation 2 part 302 and the gradation 3 part 303, and (iii) between the gradation 3 part 303 and a background 304. Similarly, the multi-gradation character 315 illustrated in FIG. 4 is arranged such a gradation difference (difference in brightness) between the character font 310 and the gradation 1 part 311 is identical to those (i) between the gradation 1 part 311 and the gradation 2 part 312, (ii) between the gradation 2 part 312 and the gradation 3 part 313, and (iii) between the gradation 3 part 313 and the background 304.

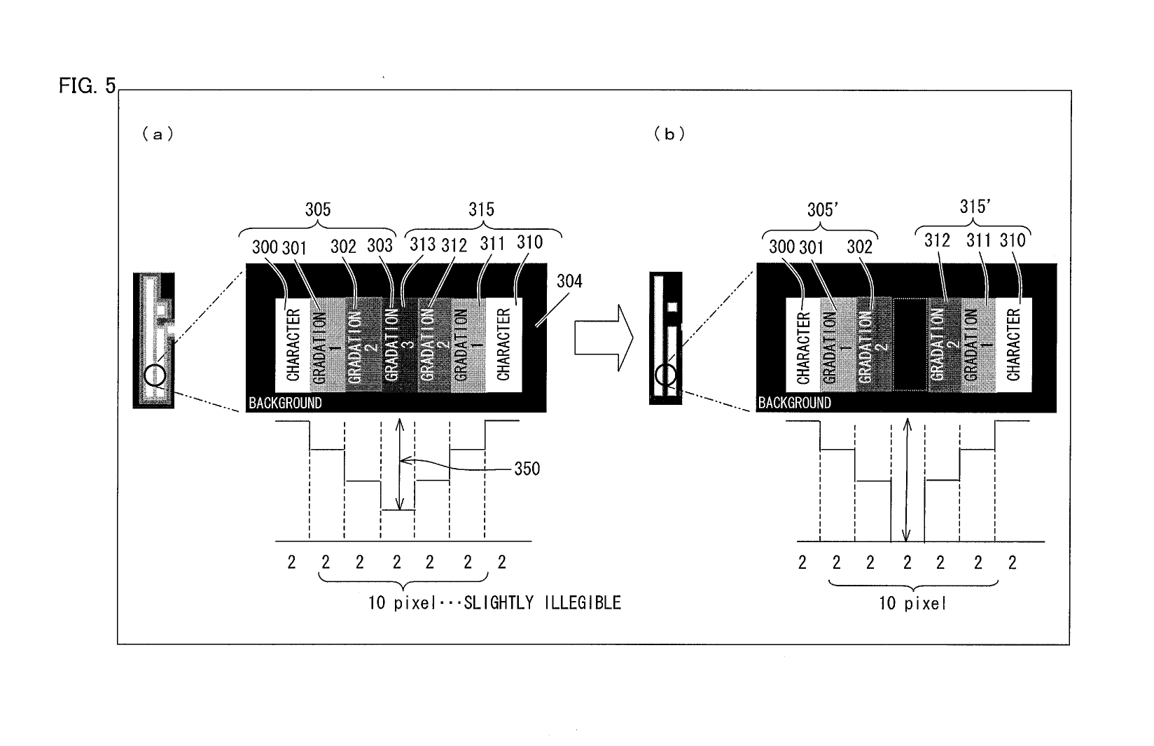

(a) of FIG. 5 illustrates a state where an inter-character space between the multi-gradation characters 305 and 315 (see FIG. 4) is narrowed, so that the gradation 3 part 303 of the multi-gradation character 305 overlaps with the gradation 3 part 313 of the multi-gradation character 315.

As has been described, the multi-gradation character 305 is arranged such that the gradation difference (difference in brightness) between the character font 300 and the gradation 1 part 301 is identical to those (i) between the gradation 1 part 301 and the gradation 2 part 302, (ii) between the gradation 2 part 302 and the gradation 3 part 303, and (iii) between the gradation 3 part 303 and a background 304. Furthermore, the multi-gradation character 315 is also similarly arranged. Therefore, in this case, a gradation difference 350 (350: reference numeral) accounts for 75% of the gradation difference between the respective character fonts 300 and 310 and the background 304. Note that, as is clear from (a) of FIG. 5, such a gradation difference 350 indicates a gradation difference (difference in brightness) between a gradation (brightness) of the character font 300 of the multi-gradation character 305 and a gradation (brightness) of an intermediate part between the multi-gradation characters 305 and 315. In the step S5 illustrated in FIG. 1, the phrase “measures a gradation difference” means measuring the gradation difference 350.

In a case where the display method of an example of the present invention (see (a) of FIG. 1) is employed, it is determined, in the step S6, that the gradation difference 350 accounts for 50% or more of N-gradation. However, it is determined, in the step S7, that the gradation difference 350 accounts for less than 80% of the N-gradation. Therefore, the third gradation is removed, that is, the gradation 3 parts 303 and 313 are removed. A gradation difference after the gradation 3 parts 303 and 313 are removed is then measured in the steps S5. Needless to say, this gradation difference accounts for 100% of the N-gradation. It is therefore determined, in the step S7, that the gradation difference accounts for 100% of the N-gradation. Accordingly, the process ends. (b) of FIG. 5 illustrates a state where the process has ended.

Note that, according to an example illustrated in FIG. 4, corrected multi-gradation characters illustrated in (b) of FIG. 5 are also generated even in the modification illustrated in (c) of FIG. 1.

As a result, the multi-gradation character 305 is displayed as a corrected multi-gradation character 305′ having gradation 1 part 301 and the gradation 2 part 302, and the multi-gradation character 315 is displayed as a corrected multi-gradation character 315′ having the gradation 1 part 311 and the gradation 2 part 312. This causes each of the multi-gradation characters to lose one of the gradations. However, each visibility of the multi-gradation characters hardly becomes worse although a display quality of the each of the multi-gradation characters is slightly reduced. It is thus possible to narrow the inter-character space instead of greatly reducing, when taken as a whole, a display quality of the multi-gradation characters.

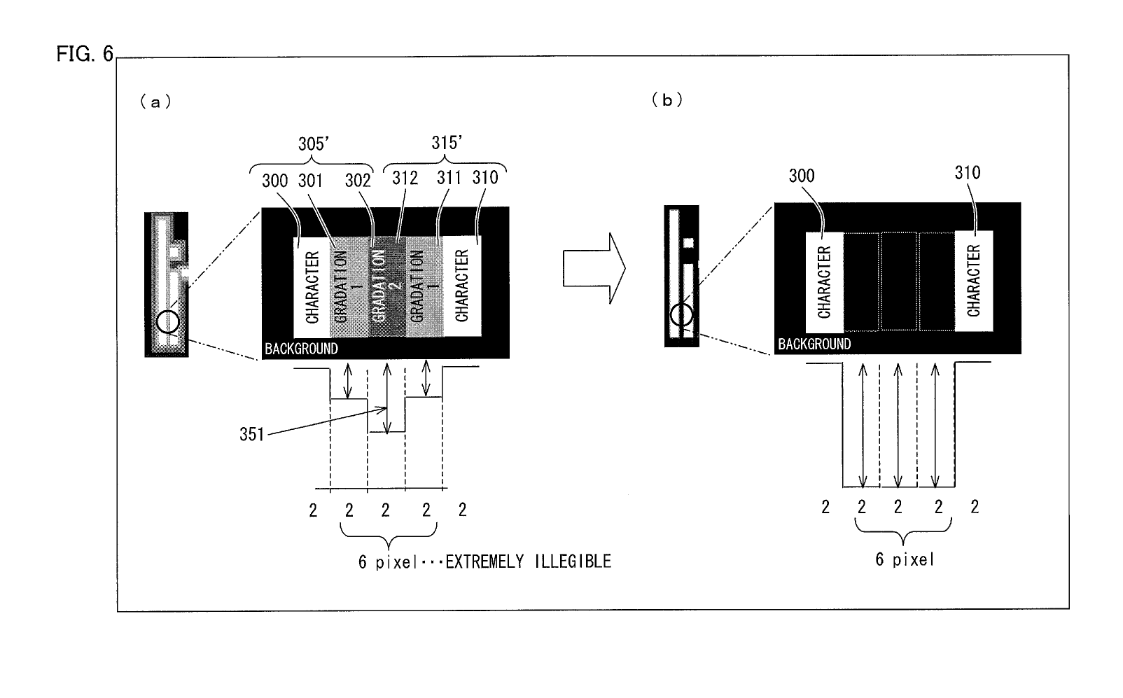

FIG. 6 illustrates how the “step of preparing corrected multi-gradation characters by correcting the a gradation of each of the multi-gradation characters” is carried out, in a case where the inter-character space between the multi-gradation characters 305 and 315 is further narrowed as compared with the case illustrated in FIG. 5. FIG. 6 illustrates a state where the inter-character space between the multi-gradation characters 305 and 315 illustrated in FIG. 4 is further narrowed as compared with the case illustrated in FIG. 5 and where the gradation 2 part 302 of the multi-gradation character 305 overlaps with the gradation 2 part 312 of the multi-gradation character 315.

In this case, the gradation difference measured in the step S5 illustrated in FIG. 1 corresponds to a gradation difference 351 (351: reference numeral) illustrated in (a) of FIG. 6. The gradation difference 351 accounts for 50% of the N-gradation, that is, does not account for more than 50% of the N-gradation. Therefore, all of the gradations are removed (see (b) of FIG. 6). The multi-gradation characters 305 and 315 results in that the character fonts 300 and 310 are merely displayed, respectively. Such an improvement in display quality of the characters that is observed in a case where the multi-gradation characters are displayed is not expected. However, it is possible to secure the visibility of the characters and satisfy a minimum requirement for display of the characters.

The above description has been given on a premise that a gradation 1, part, a gradation 2 part, and a gradation 3 part of a character font change in brightness by the same degree of brightness (luminance). The change in brightness of the gradation 1 part, the gradation 2 part, and the gradation 3 part is not limited to such, but can be freely set depending on a user's taste or a purpose of use of a character. For example, in a case where it is desired to accurately convey information, the brightness of each of the gradation 1 part, a gradation 2 part, and a gradation 3 part is set so that an improvement in visibility is achieved. In a case where a visual quality (design) is considered more important than the accurate conveyance of the information, the brightness of each of the gradation 1 part, a gradation 2 part, and a gradation 3 part is set at a little sacrifice of the visibility so that the quality of the character to be displayed is improved.

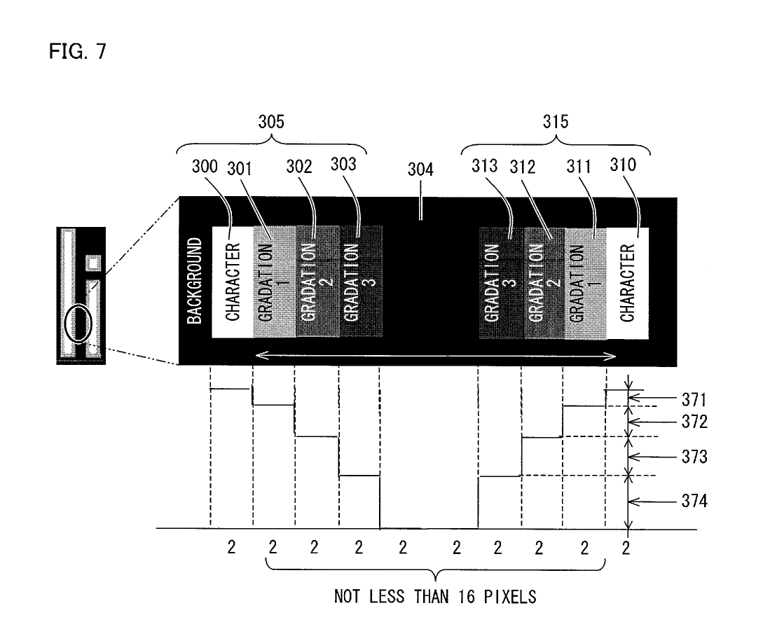

FIG. 7 illustrates an example of multi-gradation characters in which gradations added to a contour of each of character fonts are arranged such that a change in brightness is bigger from a side close to the each of the character fonts toward a side distant from the each of the character fonts. That is, (i) a difference in brightness between the character font 300 and the gradation 1 part 301 is assumed to be a difference 371, (ii) a difference in brightness between the gradation 1 part 301 and the gradation 2 part 302 is assumed to be a difference 372, (iii) a difference in brightness between the gradation 2 part 302 and the gradation 3 part 303 is assumed to be a difference 373, and (iv) a difference in brightness between the gradation 3 part 303 and the background 304 is assumed to be a difference 374 (see FIG. 7). In this case, those differences are arranged such that the difference 371<the difference 372<the difference 373<the difference 374. It is considered to logarithmically change such gradation differences.

In general, it is said that senses of a human are each converted into a logarithm. It is therefore expected that a multi-gradation character, in which a gradation is added to a contour of a character font, is felt to be smoother by many people. Furthermore, it is expected that no feeling of strangeness is given to many people, by arranging the multi-gradation character so that the gradation, added to the contour of the character font, is reduced. In this case, merely by removing a gradation 3 part, the multi-gradation character is greatly contrasted with the background. This brings about a great effect of improving visibility.

### Embodiment 2

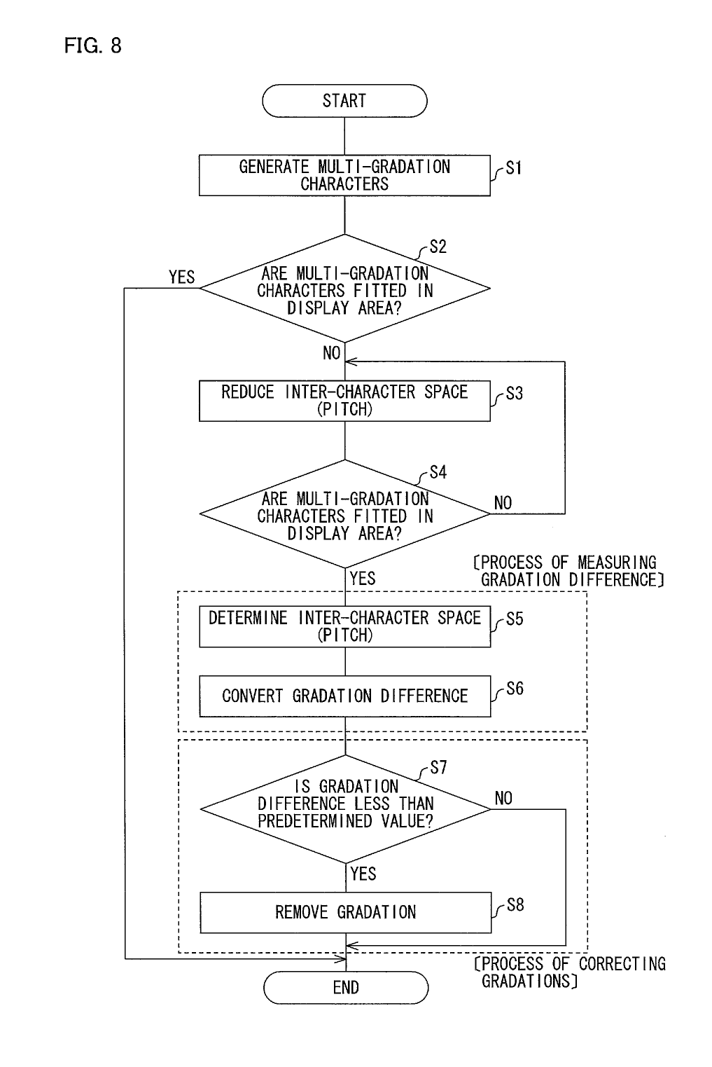

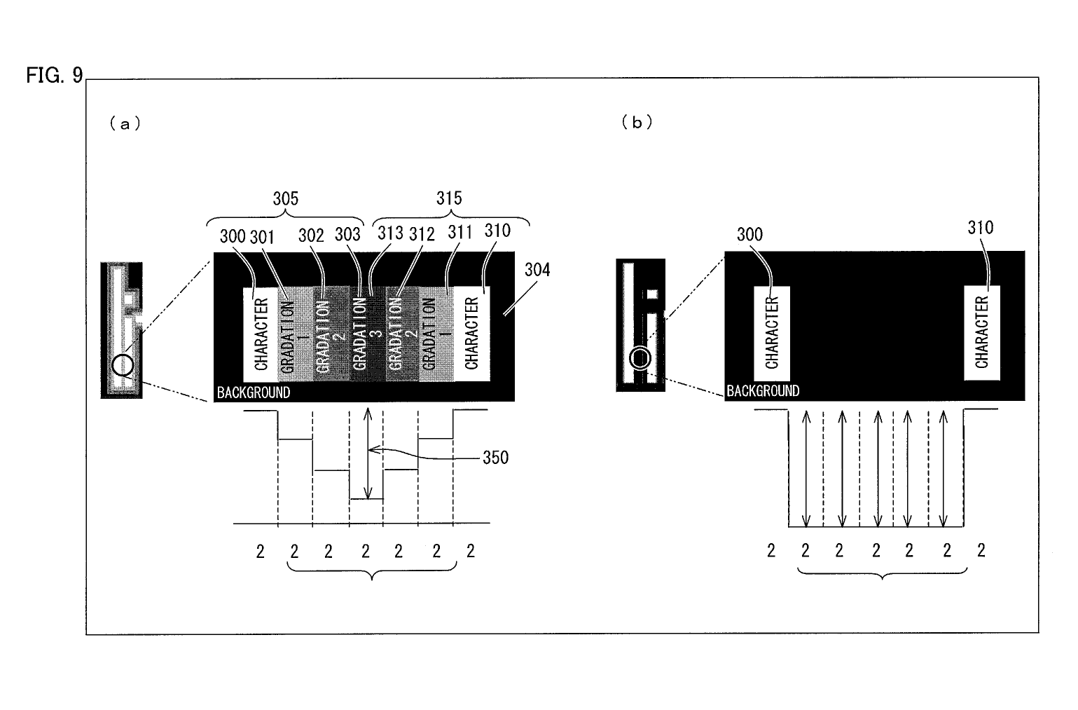

FIGS. 8, 9, and 10 each illustrate Embodiment 2 of the present invention. The following description will discuss, with reference to FIGS. 8 and 9, a method of displaying multi-gradation characters of Embodiment 2.

Basically, the method of displaying multi-gradation characters of Embodiment 2 is substantially identical to that of Embodiment 1 which has been described with reference to FIG. 1 (see FIG. 8). However, the method of displaying multi-gradation characters of Embodiment 2 is slightly different from that of Embodiment 1 in step of preparing corrected multi-gradation characters by correcting a gradation of each of multi-gradation characters. Note that, as a step of measuring a gradation difference, a step identical to that described with reference to (b) of FIG. 1 is illustrated in FIG. 8.

Since steps S1 through S6 of FIG. 8 have been already described with reference to FIG. 1, descriptions of the steps S1 through S6 will be omitted here, and “process of correcting gradation” illustrated as steps S7 and S8 in FIG. 8 will be described here.

According to Embodiment 2, a “predetermined value” which serves as a standard of determination carried out in the step S7 is pre-registered as a first gradation difference. For example, 80% is registered as the predetermined value (first gradation difference). In a case where a gradation difference measured in the step S6 accounts for not less than 80% (that is, the gradation difference accounts for 80% or more), multi-gradation characters generated in the step S1 are displayed as they are without gradation correction. In a case where the gradation difference accounts for less than 80%, all of gradations are removed, so that character fonts are merely displayed. Needless to say, the predetermined value can be alternatively 70%, instead of 80%.

With reference to (a) and (b) of FIG. 9, the method of displaying multi-gradation characters of Embodiment 2 will be described in more detail. (a) of FIG. 9 illustrates a state where multi-gradation characters are fitted in a predetermined space in the step S3 illustrated in FIG. 8, the state being identical to that illustrated in (a) of FIG. 5. In a case where (i) a gradation difference 350 (350: reference numeral) accounts for 75% and (ii) a predetermined value is 80%, all of gradations are removed (step S8).

(b) of FIG. 9 illustrates a state where all of the gradations have been removed. In this case, the multi-gradation characters are no longer displayed, and character fonts, that is, normal characters are merely displayed. This process is simple and effective in improving visibility. For example, the process is effective in a case where a display screen is originally small, such as a case where a display screen is small. Note that the process is identical to that illustrated in FIG. 6.

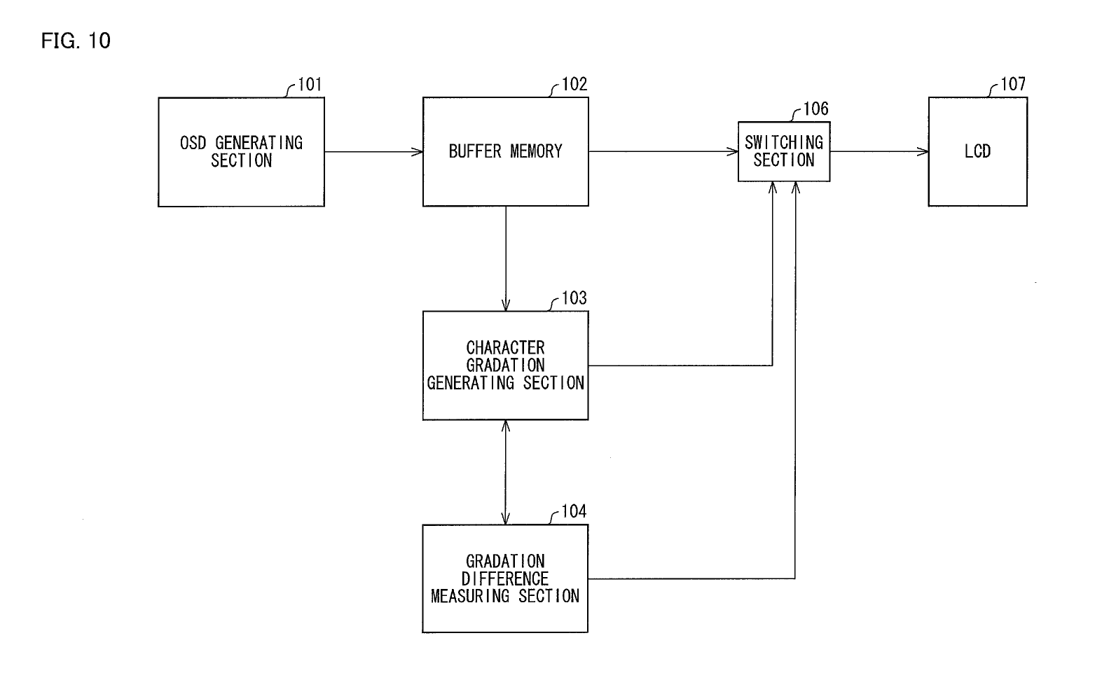

FIG. 10 illustrates an example of a display device which can achieve the method of displaying multi-gradation characters of Embodiment 2. The display device illustrated in FIG. 10 basically has a configuration identical to that of the display device (see FIG. 3) of Embodiment 1, except that the display device illustrated in FIG. 10 includes no corrected multi-gradation character generating section 105 illustrated in FIG. 3. This causes the display device illustrated in FIG. 10 to have a simpler configuration. Specifically, according to the display device illustrated in FIG. 3, it is premised that the corrected multi-gradation character generating section 105 corrects a gradation of each of multi-gradation characters. In contrast, the display device of Embodiment 2 is only necessary to display, as a special example of corrected multi-gradation characters, characters whose respective gradations are not corrected, that is, characters, each of which is outputted from an OSD generating section 101 and in each of which no gradation is added to a contour of a character font. Therefore, the display device of Embodiment 2 includes a switching section 104 so that such a desired operation is conducted.

The following description will briefly discuss operation of the display device (see FIG. 10) for displaying a multi-gradation character.

Character data, which is supplied from the OSD generating section 101 and whose characters are to be displayed in a predetermined display area, is temporarily stored in a buffer memory 102. A character gradation generating section 103 generates multi-gradation characters by adding a gradation of 1 or more to each of the characters of the character data outputted by the OSD generating section 101. A gradation difference measuring section 104 measures a gradation difference of multi-gradation characters generated by the character gradation generating section 103. Note here that although a detailed description will be omitted here, the term “measure a gradation difference of multi-gradation characters” means measuring a gradation difference 350 (350: reference numeral) illustrated in (a) of FIG. 5, as described with reference to FIG. 5.

In a case where a measured gradation difference accounts for less than a predetermined value, for example, 75%, the switching section 106 causes a display section such as an LCD to display the characters which are stored in the buffer memory 102 and to each of which no gradation is added. In a case where the gradation difference accounts for the predetermined value or more, the switching section 106 causes the LCD to display the multi-gradation characters generated by the character gradation generating section 103.

Note that character font parts of the respective multi-gradation characters are set so as to be visible against a background of the multi-gradation characters. For example, in a case where the multi-gradation characters are displayed in the background which is dark or black, the character font parts are preferably white. In a case where the background is white or bright, the character font parts are preferably dark, for example, black. Alternatively, the entire predetermined display area in which the multi-gradation characters are to be displayed can be dark or bright depending on colors of the respective character fonts.

As described above, it goes without saying that the multi-gradation characters have good visibility in a case where a difference in luminance is large between the background and the respective character font parts. According to the present invention, as has been described, it quite effectively prevents a deterioration in visibility, especially in a case where (i) multi-gradation characters are displayed whose difference in luminance is small between the colors (character colors) of the respective character font parts and a color (background color) of the background and (ii) the multi-gradation characters have an inter-character space which is narrow. That is, according to the present invention, even in a case where the inter-character space is narrowed in a video which cannot secure a large difference in luminance between the character color and the background color, due to a requirement for a screen configuration, it is possible to effectively prevent a deterioration in visibility of the characters.

The method of displaying multi-gradation characters has been described on a premise that a plurality of multi-gradation characters are arranged. However, it is possible to employ the method of displaying multi-gradation characters of the present invention even in a case where a single character is displayed. For example, in a ease where a single multi-gradation character, which can be displayed with sufficient visibility on a display, having a large number of pixels, of a large-screen television receiver, is displayed on a display, having a small number of pixels, of a television receiver, “line segments” which constitute the single multi-gradation character becomes closer to each other, so that the multi-gradation character may deteriorate in visibility. Even in such a case, by employing the method of displaying multi-gradation characters of the present invention, it is possible to display the single multi-gradation character while preventing a deterioration in visibility instead of particularly changing a program for controlling display.

As has been described, in a case where, for example, a television receiver (i) performs PIP (Picture in Picture) display, in which another channel is displayed on a sub screen on a screen, and (ii) displays a given character string on a small screen on the sub screen without changing a design of the sub screen, a character itself of the character string becomes small and, accordingly, the same phenomenon as the above-mentioned phenomenon occurs.

### <Application to Television Receiver Etc.>

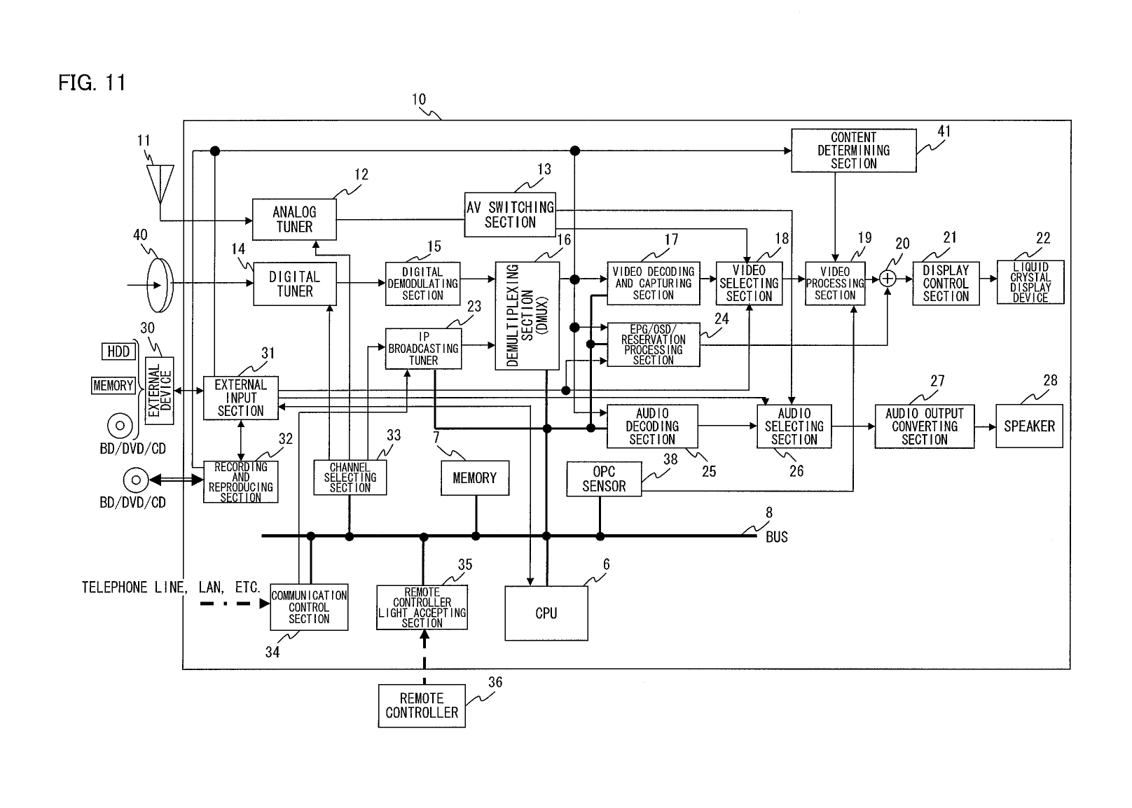

FIG. 11 is a view for explaining a case where the display device for displaying multi-gradation characters of the present invention is applied to an actual television receiver. First, an outline of the television receiver illustrated in FIG. 11 is described below.

FIG. 11 illustrates an entire configuration of a television receiver 10 including a liquid crystal display device 22 whose screen size is, for example, 16:9 (1920×1010 dots). The television receiver 10 illustrated in FIG. 11 is arranged such that the liquid crystal display device 22 displays OSD data and the like generated by an ODS generating section. The television receiver 10 includes a CPU 6 and a memory 7, which are connected to a bus 8. Operation of the television receiver 10 is controlled by the CPU 6 executing various control programs stored in the memory 7.

That is, the television receiver 10 illustrated in FIG. 11 is controlled by a computer system including the CPU 6. A program for causing the computer system to operate the television receiver 10 is stored in the memory 7. Note that, needless to say, the liquid crystal display device is not limited to one whose screen size is 16:9 in aspect ratio.

Note that the memory 7 is generally constituted by an RAM. However, the memory 7 can further include an ROM. The memory 7 can further include a rewritable flash memory. The memory 7 stores an OS, various sets of control software, and the like each for causing the CPU to operate. The memory 7 also stores, for example, (i) data on program information, such as EPG data, received via a broadcast wave and (ii) image data for OSD which image data is required in a case where OSD display is carried out. The memory 7 has a work area which serves as a work memory necessary for each control operation.

The television receiver 10 includes an analog tuner 12, in addition to a digital tuner 14. This allows the television receiver 10 to also receive an analog broadcast. An external input section 31 of the television receiver 10 is arranged to be connected to various external devices 30 which includes a solid-state memory such as an HDD and an SD card, and a disk device such as a BD (Blu-ray Disk), a DVD, and a CD. The television receiver 10 further includes, in its main body, a BD/DVD/CD recording and reproducing section 32. The television receiver 10 further includes an IP broadcast tuner 23. This allows the television receiver 10 to also receive an IP broadcast.

The television receiver 10 further includes an AV switching section 13, a digital demodulation section 15, a demultiplexing section (DMUX) 16, a video decoding and capturing section 17, a video selecting section 18, a video processing section 19, an adder circuit 20, a display control section 21, the liquid crystal display device 22, an EPG/OSD/reservation processing section 24, an audio decoding section 25, an audio selecting section 26, an audio output converting section 27, a speaker 28, a channel selecting section 33, a communication control section 34, and a remote control light receiving section 35. The television receiver 10 further includes an OPC (optical) sensor 38 for detecting surrounding brightness.

The “EPG/OSD/reservation processing section 24” of the television receiver 10 has a function identical to that of the “OSD generating section 101” (see FIGS. 3 and 10) of the present invention.

The analog tuner 12 selects an analog television broadcast signal which is received via an antenna 11 for receiving an analog broadcast. The analog tuner 12 selects a channel in response to an instruction, to make a selection, given by the channel selecting section 33. A signal received from the analog tuner 12 is separated, by the AV switching section 13, into an audio signal and a video signal. The video signal is supplied to the video selecting section 18, whereas the audio signal is supplied to the audio selecting section 26.

The digital tuner 14 selects a digital television broadcast signal which is received via an antenna 40 for receiving a digital broadcast. The digital tuner 14 selects a channel to be received, in response to an instruction, to make a selection, given by the channel selecting section 33. A signal received from the digital tuner 14 is demodulated by the digital demodulation section 15 and is then supplied to the demultiplexing section (DMU) 16.

The IP broadcast tuner 23 selects an IP broadcast which is received via the communication control section 34 connected to a telephone network, an LAN, or the like. The IP broadcast tuner 23 selects a specific IP broadcast to be received, in response to an instruction, to make a selection, given by the channel selecting section 33. An output signal of the IP broadcast tuner 23 is supplied to the demultiplexing section (DMUX) 16.

The demultiplexing section (DMUX) 16 demultiplexes multiplexed video data and multiplexed audio data each of which is received from the digital demodulation section 15 or the IP broadcast tuner 23, and then supplies (i) the video data thus demultiplexed to the video decoding and capturing section 17 and (ii) the audio data thus demultiplexed to the audio decoding section 25. Furthermore, the demultiplexing section (DMUX) 16 extracts data, such as EPG data, contained in a broadcast signal, and then supplies the data thus extracted to the EPG/OSD/reservation processing section 24. Note that the CPU 6 controls the memory 7 to store therein a broadcast wave signal extracted by the demultiplexing section (DMUX) 16, as necessary.

The video decoding and capturing section 17 decodes video data demultiplexed by the demultiplexing section (DMUX) 16 or captures, as a still image, video information contained in the video data. A video signal, which the video decoding and capturing section 17 obtains by decoding the video data, is supplied to the video selecting section 18. As has been described, the video selecting section 18 has received (i) a video signal from the analog tuner 12 and (ii) a video signal from the external input section 31. In response to a control signal supplied from the CPU 6, the video selecting section 18 selects one of the video signals thus supplied, and then supplies a selected one of the inputted video signals to the video processing section 19.

The video processing section 19 carries out video processing, such as noise-reduction, adjustment of sharpness, and adjustment of contrast, with respect to an inputted video signal. This causes the video data to be converted into a video signal most suitable for the liquid crystal display device 22.

The display control section 21 includes a driving circuit for causing the liquid crystal display device 22 to display a video of received video data. The display control section 21 supplies, to the liquid crystal display 22, EPG (Electronic Program Guide) data or OSD (On Screen Display) data, each of which is added by the adder circuit 20 and which is received from the EPG/OSD/reservation processing section 24, together with the video data received from the video processing section 19. The liquid crystal display device 22 displays, on a screen, the video of the video data thus received.

The audio decoding section 25 decodes audio data demultiplexed by the demultiplexing section (DMUX) 16. The audio decoding section 25 supplies, to the audio selecting section 26, an audio signal obtained by decoding the audio data.

The CPU 6 controls the audio selecting section 26 to (i) select an audio signal, corresponding to a video signal which is selected by the video selecting section 18, from audio signals received from the AV switching section 13, the external input section 31, and the audio decoding section 25, and then (ii) transmit the audio signal to the speaker 28 via the audio output converting section 27. Specifically, the audio output converting section 27 converts a received audio signal into a signal most suitable for reproduction by the speaker 28, and then supplies the signal to the speaker 28.

The remote control light receiving section 35 accepts an optical signal from a remote controller 36 so as to receive a control signal from the remote controller 36. The communication control section 34 controls communication to be established via a communication network such as a telephone line, an LAN, or the Internet.

The EPG/OSD/reservation processing section 24 creates an electronic program guide in accordance with EPG data which is regularly updated and stored. Further, the EPG/OSD/reservation processing section 24 draws an image of OSD data which is stored in the memory 7 in advance. The OSD data indicates data for drawing various sets of information, such as a setting menu screen, a volume gauge, a current time, and a selected channel, each of which is stored in the memory 7 in advance. Furthermore, the EPG/OSD/reservation processing section 24, for example, presets timer viewing or timer recording of a program with the use of the electronic program guide.

As has been described, the OSD data includes data and the like such that, in a case where data in English is switched to German, the data changes in length. Therefore, as has been described, the method of displaying multi-gradation characters and the like of the present invention can be effectively employed, in a case where television receivers having worldwide specification, which are common in configuration of hardware and which allows multilingual display by software (program), display a text of the OSD data with the use of a multi-gradation character while fitting the text in a predetermined space.

The above description has taken a television receiver as an example. However, it goes without saying that the method of displaying multi-gradation characters of the present invention can be employed also in a case where a mobile device with which a television can be viewed, such as a mobile phone, a car navigation system, and a mobile game terminal, receives a television. Furthermore, it is obvious that the present invention can be effectively applied to all of devices which display a multi-gradation character in multiple languages, even in a case where the devices have no function for receiving a television.

<Program, Recording Medium>

Each block of the display device for displaying multi-gradation characters illustrated in FIGS. 3 and 10 can be implemented by hardware such as a logic circuit provided on an integrated circuit (IC chip) or can be alternatively implemented by software with the use of a CPU (Central Processing Unit). Note that the CPU can be provided in the display device of the present invention as a CPU exclusive to carry out the method of displaying multi-gradation character of the present invention. In a case where the method of displaying multi-gradation characters of the present invention is applied to the television receiver, a CPU provided in the television receiver can be alternatively used.

In a case where each block of the display device is implemented as software, the display device for displaying multi-gradation characters includes: a CPU which executes a command of a program that carries out the foregoing functions; a ROM (Read Only Memory) in which the program is stored; a RAM (Random Access Memory) in which the program is loaded; and a storage device (recording medium) such as a memory in which the program and various sets of data are stored. The object of the present invention can be attained by (i) supplying, to the display device for displaying multi-gradation characters, the recoding medium in which program codes (an executable program, an intermediate code program, and a source program) of a program for controlling the display device, which is implemented by software that executes the foregoing functions, are computer-readably recorded and (ii) causing a computer (or a CPU or an MPU) of the display device to read and execute the program codes recorded in the recording medium.

Examples of the recording medium includes: (i) tapes such as a magnetic tape and a cassette tape; (ii) disks including magnetic disks, such as a floppy (Registered Trademark) disk and a hard disk, and optical disks, such as a CD-ROM, an MO, an MD, a DVD, and a CD-R; (iii) cards such as an IC card (including a memory card) and an optical card; (iv) semiconductor memories such as a mask ROM, EPROM, EEPROM, and a flash ROM; and (v) logic circuits such as a PLD (Programmable logic device) and an FPGA (Field Programmable Gate Array).

The display device can be connected to a communication network so that the program codes are supplied to the display device via the communication network. This communication network is not limited to any particular one, provided that the program codes can be transmitted. Examples of the communication network include the Internet, an intranet, an extranet, a LAN, ISDN, VAN, a CATV communications network, a virtual private network, a telephone network, a mobile telecommunications network, and a satellite communication network. Further, a transmission medium by which the communication network is constituted is not limited to any particular one, provided that the program codes can be transmitted. Examples of the transmission medium include: wired transmission media such as IEEE1394, a USB, a power-line carrier, a cable TV circuit, a telephone line, and ADSL (Asymmetric Digital Subscriber Line); and wireless transmission media such as infrared communication systems such as IrDA and a remote control, Bluetooth (Registered Trademark), IEEE802.11 wireless communication system, HDR (High Digital Rate), NFC (Near Field Communication), DLNA (Digital Living Network Alliance), a mobile phone network, a satellite circuit, and a digital terrestrial network.

<Summary>

As has been described, a method of displaying multi-gradation characters in accordance with an embodiment of the present invention is a method of displaying multi-gradation characters, which method allows inputted character data to be displayed as multi-gradation characters by adding a gradation of 1 or more to each contour of character fonts of the inputted character data,

the method including the steps of:

(a) generating the multi-gradation characters by adding the gradation of 1 or more to the each contour of the character fonts of the inputted character data;

(b) measuring a gradation difference between (i) each gradation of character font parts of the multi-gradation characters and (ii) a gradation of a corresponding intermediate part between adjacent ones of the multi-gradation characters; and

(c) generating corrected multi-gradation characters by correcting the gradation of 1 or more of each of the multi-gradation characters in accordance with the gradation difference measured in the step (b),

in accordance with the gradation difference measured in the step (b), the corrected multi-gradation characters being outputted instead of characters to each of which no gradation is added.

According to the above configuration, in a case where a given character string is displayed in a predetermined space, it is possible to display the character string with the use of high-quality characters, that is, multi-gradation characters while automatically minimizing a deterioration in visibility, depending on the predetermined space in which the character string is to be displayed. Further, in a case where the predetermined space in which the character string is to be displayed is extremely narrow, all gradation(s) added to each of the multi-gradation characters is/are automatically removed. This makes it possible to display the character sting while preventing the deterioration in visibility. Especially, in a case where (I) the multi-gradation characters are displayed which are arranged such that a difference in luminance is small between (i) each color of character font parts (character color) of the multi-gradation characters and (ii) a color of a background (background color) of the multi-gradation characters and (II) the multi-gradation characters are displayed while an inter-character space between the multi-gradation characters is being narrowed, it is possible to quite effectively prevent the deterioration in visibility.

The method of displaying multi-gradation characters is arranged such that the step (b) includes:

(b′) measuring an inter-character space between the respective multi-gradation characters; and

(b″) converting the gradation difference in accordance with the inter-character space thus measured.

According to the above configuration, it is possible to accurately measure the gradation difference without measuring actual levels of brightness in the character font parts of the multi-gradation characters and in the corresponding intermediate part between adjacent ones of the multi-gradation characters. Therefore, particular hardware and the like for measuring the gradation difference are not needed. That is, it is possible to measure the gradation difference by (i) pre-registering a level and a width of the gradation(s) added to the contour of each of the character fonts and (ii) measuring the inter-character space.

The method of displaying multi-gradation characters is arranged such that, in the step (c), in a case where the gradation difference measured in the step (b) is less than a predetermined first gradation difference, all added gradation(s) is/are removed.

According to the above configuration, with a relatively simple process, it is possible to display the multi-gradation characters depending on the predetermined space in which the multi-gradation characters are to be displayed. It is therefore possible to employ the method of the present invention for a mobile device and the like which are difficult to have a high-speed CPU.

The method of displaying multi-gradation characters is arranged such that the step (c) includes:

(c′) removing all added gradation(s), in a case where the gradation difference measured in the step (b) is not more than a predetermined first gradation difference; and

(c″) removing an added gradation until the gradation difference measured in the step (b) is not less than a predetermined second gradation difference which is larger than the predetermined first gradation difference, in a case where the gradation difference is more than the predetermined first gradation difference but less than the predetermined second gradation difference,

multi-gradation characters being outputted each of which gradation difference is not less than the second gradation difference.

According to the above configuration, each of the outputted and displayed multi-gradation characters has such a gradation(s) that a gradation difference is at least the second gradation difference or more. It is therefore possible to secure visibility of a set value.

The method of displaying multi-gradation characters is arranged such that, in the step (c), in a case where the gradation difference measured in the step (b) is more than the predetermined first gradation difference but less than the predetermined second gradation difference, an added gradation farthest from each of the character font parts is removed.

According to the above configuration, with a relatively simple process, it is possible to secure minimum visibility.

The method of displaying multi-gradation characters is arranged such that, in the step (a), the gradation of 1 or more added to the each contour of the character fonts is a gradation of a level obtained by evenly dividing a difference between (i) the each gradation of the character font parts and (ii) a gradation of a background of the multi-gradation characters.

According to the above configuration, it is possible to easily calculate the gradation difference by measuring the inter-character space between the multi-gradation characters.

The method of displaying multi-gradation characters is arranged such that, in the step (a), the gradation of 1 or more added to the each contour of the character fonts is arranged such that a change in gradation becomes smaller toward a side close to a corresponding one of the character font parts and larger toward a side close to a background of the multi-gradation characters.

According to the above configuration, by merely removing a gradation farthest from each of the character font parts of the multi-gradation characters, it is possible to considerably improve the visibility. That is, with a relatively simple process, it is possible to considerably improve the visibility. That is, according to the above configuration, the multi-gradation characters are more spaced, so that the visibility is improved.

The method of displaying multi-gradation characters is arranged such that each of the character font parts of the multi-gradation characters is white, whereas a background is black.

According to the above configuration, it is possible to display the multi-gradation characters with good contrast against the background which is dark.

The method of displaying multi-gradation characters is arranged such that each of the character font parts of the multi-gradation characters is black, whereas a background is white.

According to the above configuration, it is possible to display the multi-gradation characters with good contrast against the background which is dark.

Further, as has been described, a display device for displaying multi-gradation characters in accordance with an embodiment of the present invention is a display device, including a character gradation generating section which generates multi-gradation characters by adding a gradation of 1 or more to each contour of character fonts, said display device allowing inputted character data to be displayed as the multi-gradation characters, in each of which the gradation of 1 or more is added to the each contour of the character fonts,

the display device including:

a gradation difference measuring section for measuring a gradation difference between (i) each gradation of character font parts of the multi-gradation characters and (ii) a gradation of a corresponding intermediate part between adjacent ones of the multi-gradation characters; and

a switching section for switching, in accordance with the gradation difference measured by the gradation difference measuring section, between (i) outputting of characters to each of which no gradation is added and (ii) outputting of the multi-gradation characters which are generated by the character gradation generating section and in each of which the gradation of 1 or more is added to the each contour of the character fonts.

According to the display device, in a case where the gradation difference measured in the step (b) is less than the predetermined first gradation difference, it is possible to quite easily remove the all added gradation(s).

Further, as has been described, a display device for displaying multi-gradation characters in accordance with an embodiment of the present invention is a display device, including a character gradation generating section which adds a gradation of 1 or more to each contour of character fonts, said display device allowing inputted character data to be displayed as multi-gradation characters in each of which the gradation of 1 or more is added to each contour of character fonts,

the display device including:

a gradation difference measuring section for measuring a gradation difference between (i) each gradation of character font parts of the multi-gradation characters and (ii) a gradation of a corresponding intermediate part between adjacent ones of the multi-gradation characters; and

a corrected multi-gradation character generating section for generating corrected multi-gradation characters by correcting the gradation of 1 or more of each of the multi-gradation characters generated by the character gradation generating section,

said display device being capable of switching, in accordance with the gradation difference measured by the gradation difference measuring section, between (i) characters to each of which no gradation is added and (ii) the corrected multi-gradation characters.

According to the above configuration, it is possible to provide a display device capable of displaying, depending on a predetermined space in which multi-gradation characters are to be displayed, the multi-gradation characters with high quality while automatically minimizing a deterioration in visibility, in a case where a given character sting is displayed in the predetermined space. Further, it is possible to provide a display device capable of displaying the multi-gradation characters while preventing the deterioration in visibility by automatically removing all gradation(s) added to each of the multi-gradation characters, in a case where the predetermined space in which the multi-gradation characters are to be displayed is extremely narrow.

Further, as has been described, a television receiver in accordance with an embodiment of the present invention includes a display device described above, and a mobile device in accordance with the present invention includes a display device described above.

According to the above configuration, it is possible to provide a television receiver or a mobile device each of which is capable of displaying the high-quality characters, that is, the multi-gradation characters while preventing the deterioration in visibility at a minimum.

Further, as has been described, a program in accordance with an embodiment of the present invention is capable of causing each section of a display device in accordance with the present invention to function. Therefore, with the use of the program, it is possible to realize a television receiver or a mobile device for each of which the method of displaying multi-gradation characters of the present invention is employed.

Further, as has been described, a recording medium in accordance with an embodiment of the present invention is a recording medium in which a computer program is recorded which is capable of causing the display device in accordance with the present invention to operate. According to the recording medium, it is possible to easily distribute or provide the computer program which is capable of realizing the method of displaying multi-gradation characters of the present invention.

<Supplementary Notes>

Note that the above-described Embodiments should be considered to be only illustrative in every aspect and not to be limitative. The scope of the present invention is defined not only by the descriptions but by claims, and is intended to encompass all alterations within the meaning of and within the scope of the claims and their equivalents.

### INDUSTRIAL APPLICABILITY

The present invention relates to a method of displaying multi-gradation characters and a display device for displaying multi-gradation characters, each of which is capable of causing all display panels, such as an LCD and an EL, employed for various information devices typified by a television receiver to display a high-quality multi-gradation character. The present invention has high industrial applicability.

### REFERENCE SIGNS LIST

101 OSD generating section
102 Buffer memory
103 Character gradation generating section
104 Gradation difference measuring section
105 Corrected multi-gradation character generating section (character gradation correcting section)
106 Switching section
107 Liquid crystal display device
200 Part of character font of multi-gradation character
201 Part, to which gradation 1 is added, of multi-gradation character
202 Part, to which gradation 2 is added, of multi-gradation character
203 Background
210 Gradation (level of brightness) of character font part of multi-gradation character
211 Gradation (level of brightness) of part, to which gradation 1 is added, of multi-gradation character
212 Gradation (level of brightness) of part, to which gradation 2 is added, of multi-gradation character
213 Gradation (level of brightness) of background
300,310 Character font part of multi-gradation character
301,311 Part, to which gradation 1 is added, of multi-gradation character
302,312 Part, to which gradation 2 is added, of multi-gradation character
303,313 Part, to which gradation 3 is added, of multi-gradation character
304 Background
305 Multi-gradation character having character font 310, gradation 1 part 311, gradation 2 part 312, and gradation 3 part 313
315 Multi-gradation character having character font 300, gradation 1 part 301, gradation 2 part 302, and gradation 3 part 303
350 Gradation difference (difference in level of brightness) between character font part and part to which gradation 3 is added.

1-15. (canceled)

16. A method of displaying multi-gradation characters, in each of which a contour line, having a gradation of 1 or more, is further added to a character font,
said method comprising the step of:
(a) outputting, instead of the multi-gradation characters, corrected multi-gradation characters obtained by correcting the gradation of 1 or more of the contour line of each of the multi-gradation characters, in a case where a gradation difference, between (i) a gradation of the character font of each of the multi-gradation characters and (ii) a gradation of a corresponding intermediate part between adjacent character fonts of the multi-gradation characters, is less than a predetermined gradation difference.

17. The method as set forth in claim 16, further comprising the steps of:
(b) generating the multi-gradation characters by adding, to each character font of inputted character data, the contour line having the gradation of 1 or more;
(c) measuring the gradation difference;
(d) generating the corrected multi-gradation characters by correcting the gradation of 1 or more of the contour line of each of the multi-gradation characters, in a case where the gradation difference measured in the step (c) is less than the predetermined gradation difference.

18. The method as set forth in claim 17, wherein
a width of the gradation of 1 or more of the contour line of each of the multi-gradation characters is predetermined, and
the step (c) includes:
(c′) measuring an inter-character space between adjacent ones of the multi-gradation characters; and
(c″) converting the inter-character space into the gradation difference.

19. The method as set forth in claim 17, wherein
in the step (d), in a case where the gradation difference measured in the step (c) is less than a predetermined first gradation difference, all added gradation(s) of the contour line of each of the multi-gradation characters is/are eliminated.

20. The method as set forth in claim 17, wherein
the step (d) includes:
(d′) eliminating all added gradation(s) of the contour line of each of the multi-gradation characters, in a case where the gradation difference measured in the step (c) is not more than a predetermined first gradation difference; and
(d″) eliminating an added gradation of the contour line of each of the multi-gradation characters which gradation is farthest from the character font until the gradation difference measured in the step (c) is not less than a predetermined second gradation difference which is larger than the predetermined first gradation difference, in a case where the gradation difference is more than the predetermined first gradation difference but less than the predetermined second gradation difference.

21. The method as set forth in claim 17, wherein
in the step (b), the gradation of 1 or more of the contour line added to the character font is a gradation of a level obtained by evenly dividing a difference between (i) the gradation of the character font and (ii) a gradation of a background.

22. The method as set forth in claim 17, wherein
in the step (b), the gradation of 1 or more of the contour line added to the character font is arranged such that a change in gradation becomes smaller toward a side close to the character font and larger toward a side distant from the character font.

23. The method as set forth in claim 16, wherein
the character font of each of the multi-gradation characters is white, whereas a background is black.

24. The method as set forth in claim 16, wherein
the character font of each of the multi-gradation characters is black, whereas a background is white.

25. A method of displaying multi-gradation characters, in each of which a contour line, having a gradation of 1 or more, is further added to a character font,
said method comprising the step of:
(i) outputting, instead of the multi-gradation characters, the character font itself to which the contour line is not added, in a case where a gradation difference, between (i) a gradation of the character font of each of the multi-gradation characters and (ii) a gradation of a corresponding intermediate part between adjacent character fonts of the multi-gradation characters, is less than a predetermined gradation difference.

26. A display device which displays multi-gradation characters, in each of which a contour line, having a gradation of 1 or more, is further added to a character font,
said display device comprising:
a switching section for outputting, instead of the multi-gradation characters, the character font itself to which the contour line is not added, in a case where a gradation difference, between (i) a gradation of the character font of each of the multi-gradation characters and (ii) a gradation of a corresponding intermediate part between adjacent character fonts of the multi-gradation characters, is less than a predetermined gradation difference.

27. A display device which displays multi-gradation characters, in each of which a contour line, having a gradation of 1 or more, is further added to a character font,
said display device comprising:
a switching section for outputting, instead of the multi-gradation characters, corrected multi-gradation characters obtained by correcting the gradation of 1 or more of the contour line of each of the multi-gradation characters, in a case where a gradation difference, between (i) a gradation of the character font of each of the multi-gradation characters and (ii) a gradation of a corresponding intermediate part between adjacent character fonts of the multi-gradation characters, is less than a predetermined gradation difference.

28. A television receiver comprising a display device recited in claim 26.

29. A television receiver comprising a display device recited in claim 27.

30. A mobile device comprising a display device recited in claim 26.

31. A mobile device comprising a display device recited in claim 27.

32. A computer-readable and non-transitory recording medium in which a program is stored, the program causing a computer to function as each means of a display device recited in claim 26.

33. A computer-readable and non-transitory recording medium in which a program is stored, the program causing a computer to function as each means of a display device recited in claim 27.
